(19) United States
(12) Patent Application Publication
(10) Pub. No.: US 2014/0086582 A1
(43) Pub. Date: Mar. 27, 2014

(54) COHERENT OPTICAL RECEIVER AND LOCAL LIGHT SWITCHING METHOD

(71) Applicant: Tadayuki Iwano, Tokyo (JP)

(72) Inventor: Tadayuki Iwano, Tokyo (JP)

(73) Assignee: NEC CORPORATION, Tokyo (JP)

(21) Appl. No.: 14/116,085

(22) PCT Filed: May 7, 2012
(86) PCT No.: PCT/JP2012/062239

§ 371 Date: Nov. 6, 2013

(30) Foreign Application Priority Data
May 11, 2011 (JP) 2011-106391

(51) Int. Cl. H04B 10/61; H04Q 11/00

(52) U.S. Cl. CPC H04B 10/61; H04Q 11/0001
USPC 398/48

(57) ABSTRACT

In order to promptly switch a wavelength of local light in conjunction with switching of a wavelength of signal light, a coherent optical receiver includes a signal light divergence unit for causing signal light to diverge to first signal light and second signal light; a local oscillation light source for generating local oscillating light (local light); an optical phase hybrid unit for causing the first signal light to interfere with the local light and outputting interference light; and a wavelength detection unit for receiving the second signal light, detecting a wavelength of the signal light on the basis of the second signal light, and thereby controlling a wavelength of the local light generated by the local oscillation light source.

### TECHNICAL FIELD

The present invention relates to a coherent optical receiver and, more particularly, to a coherent optical receiver which performs switching of the wavelength of local light in conjunction with switching of the wavelength of signal light.

### BACKGROUND ART

A wavelength division multiplexing (WDM) technology which makes multiple use of an optical fiber by simultaneously utilizing a plurality of light signals having different wavelengths has achieved a dramatic increase of the information transmission amount in optical fiber communication. Moreover, a dense wavelength division multiplexing (DWDM) technology which makes it possible to simultaneously transmit a larger number of light wavelengths than in the case of the wavelength division multiplexing and makes interval of signals be denser has been contributing to a further increase of the information transmission amount in the optical fiber communication.

Technologies contributing to a significant capacity increase of the optical fiber communication include, besides such a wavelength division multiplexing technology and a dense wavelength division multiplexing technology, a coherent optical communication technology. The coherent optical communication technology is a technology for transmitting, at a transmitting end, signal light resulting from applying a signal to the amplitude or the phase of optical electric-field, and performs coherent optical reception to the signal light at a receiving end. A digital coherent optical receiver is an optical receiver for converting a light signal which has been obtained through coherent-optical-receiving into an electric signal, and performing digital processing on the electric signal to reproduce an original signal.

In addition, similar terms of a “light signal” and “signal light” are used in this specification. The “light signal” is used as the meaning of making a “signal” a main term, and is used, for example, in such a case where it is meant that a signal is transmitted by handling light as a transmission medium therefor. Each light signal is also referred to as a “wavelength channel”. The “signal light” is used as the meaning of making “light” a main term, and is used as the meaning of light including a signal.

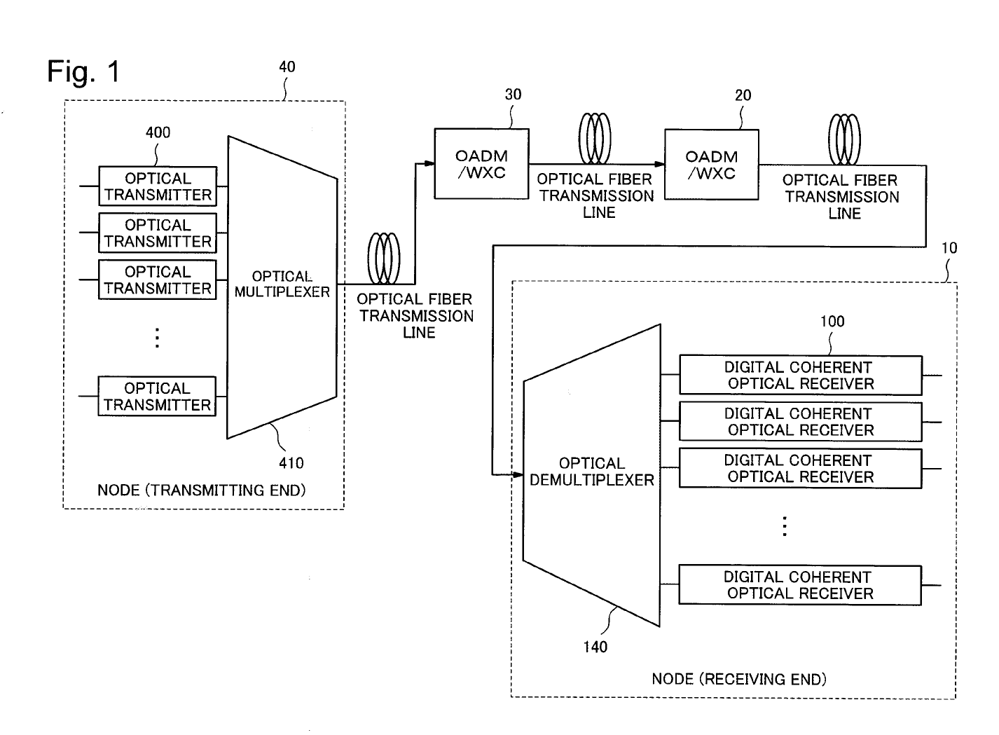

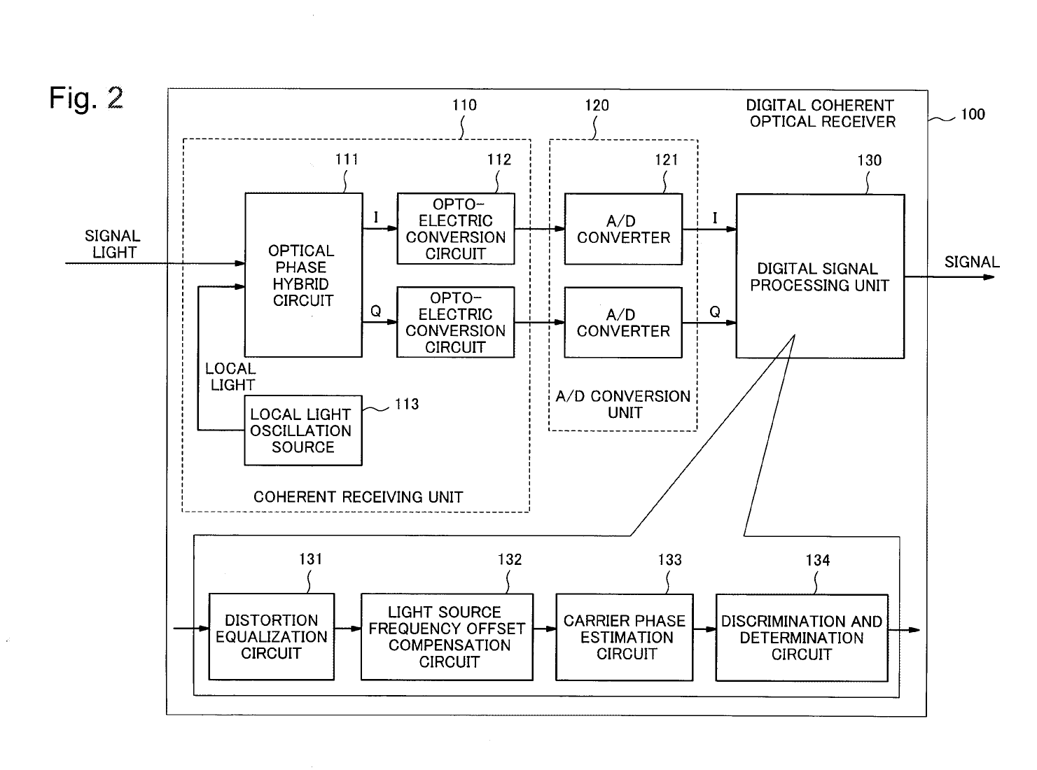

In FIG. 1, an example of a network configuration employing the dense wavelength division multiplexing technology is illustrated, and in FIG. 2, an example of a configuration of a digital coherent optical receiver employing the coherent optical communication technology is illustrated.

As shown in FIG. 1, in a network employing the dense wavelength division multiplexing technology, a node 40 located at a transmitting end and a node 10 located at a receiving end are connected to each other via an optical fiber transmission line. In each of the nodes 20 and 30 located midway of the optical fiber transmission line, wavelength channels are added and/or dropped to/from wavelength-multiplexed light signals as needed by using an optical add/drop multiplexer (OADM) or a wavelength cross connect (WXC).

The node 40 located at the transmitting end includes a plurality of optical transmitters 400 and an optical multiplexer 410. The optical transmitters 400, using lights having mutually different wavelengths, each transmit signal light resulting from applying a signal to be transmitted to the amplitude or the phase of optical electric-field of the light. The optical multiplexer 410 receives the signal lights transmitted from the respective optical transmitters, and outputs the received signal lights as a wavelength-multiplexed light signal.

The OADM or the WXC of each of the nodes 20 and 30 demultiplexes a wavelength channel to be terminated as a client signal from the wavelength-multiplexed light signal passing through the relevant node. Moreover, the OADM or the WXC adds a wavelength channel having been transmission-requested from a client side as part of the wavelength-multiplexed signal passing through the node.

The node 10 located at the receiving end includes an optical demultiplexer 140 and a plurality of digital coherent optical receivers 100. The optical demultiplexer 140 receives the wavelength-multiplexed signal having been transmitted on the optical fiber transmission line, demultiplexes the wavelength-multiplexed signal into light signals per respective wavelengths, and outputs the light signals. The digital coherent optical receivers 100 each receives signal light which has been demultiplexed by the optical demultiplexer 140 and has a wavelength different from those of the other demultiplexed signal lights and performs the coherent optical reception to the received signal light to reproduce and output a signal currently applied to the amplitude or the phase of optical electric-field of the received signal light.

A configuration and operation of the digital coherent optical receiver will be briefly described with reference to FIG. 2.

The digital coherent optical receiver 100 includes a coherent receiving unit 110, an A/D (analog/digital) conversion unit 120 and a digital signal processing unit 130.

The coherent receiving unit 110 includes an optical phase hybrid circuit 111, an opto-electric conversion circuit 112 which performs an opto-electric conversion of a signal outputted the optical phase hybrid circuit 111, and a local oscillation light source 113, and performs the coherent optical reception.

Signal light having been inputted to the coherent receiving unit 110 is inputted to the optical phase hybrid circuit 111 together with local oscillation light (local light) outputted by the local oscillation light source 113 and having the approximately same frequency as that of the signal light. The optical phase hybrid circuit 111 mixes the inputted signal light and local light and outputs interference light produced by the mixture and having a down-converted frequency. This interference light includes two sets of lights that each of phases is mutually different by 90 degrees, that is, an in-phase (I) component and a quadrature (Q) component, and the opto-electric conversion circuits 112 performs opto-electric conversions of the interference light into electric signals which indicate electric-field envelopes of the signal light, and outputs the electric signals.

The electric signals outputted from the coherent receiving unit 110 are inputted to the A/D conversion unit 120 where, for the respective components, the inputted electric signals are subjected to sampling and quantization processes in A/D converters 121, and thereby are converted into digital signals.

The digital signal processing unit 130 performs signal-waveform equalization processing and demodulation processing on the digitalized electric signals, and thereby reproduces and outputs an original signal. The digital coherent optical receiver is capable of acquiring, as electric signals, two kinds of information in relation to respective ones of both of the amplitude and the phase of optical electric-field of signal light, and thus, makes it possible to perform high accurate waveform distortion compensation by using an electric equalization filter.

In addition, with respect to such a digital coherent optical receiver, a detection method employing an intradyne method in which merely causing the frequency of signal light and that of local light to be roughly matched with each other with a frequency difference several GHz has become mainstream. The digital coherent optical receiver employing the intradyne method does not include any optical phase synchronization loop in order to simplify the receiver's configuration, so that a local oscillation light source is in a free run oscillating state, and any control of the frequency and the phase of local light is not performed.

It is necessary, therefore, for the digital coherent optical receiver to perform equalization processing on a received signal to equalize a signal distortion due to wavelength dispersion and polarization mode dispersion, and then, perform frequency offset compensation processing and phase offset compensation processing. That is, the digital signal processing unit 130 performs signal distortion equalization processing, frequency offset compensation processing and phase offset compensation processing, and then, performs decoding processing.

As shown in the bottom part of FIG. 2, the digital signal processing unit 130 includes a distortion equalization circuit 131, a light source frequency offset compensation circuit 132, a carrier wave phase estimation circuit 133 and a discrimination and determination circuit 134.

The distortion equalization circuit 131 compensates a signal distortion by using an electric equalization filter, the signal distortion due to wavelength dispersion and polarization mode dispersion caused by an event in which light is transmitted on an optical fiber transmission line. The light source frequency offset compensation circuit 132 has the function of estimating an amount of frequency misalignment between signal light and local light, and compensating the amount of frequency misalignment. The carrier wave phase estimation circuit 133 has the function of estimating an amount of phase misalignment between signal light and local light, and compensating the amount of phase misalignment. The discrimination and determination circuit 134 performs demodulation processing on a signal which has been waveform shaped by the distortion equalization circuit 131, the light source frequency offset compensation circuit 132 and the carrier wave phase estimation circuit 133 and makes a discrimination and determination with respect to the presence or absence of the signal by using a specific threshold value, and outputs a 0/1 signal.

Further, in a network employing the dense wavelength division multiplexing technology, it is possible to realize a cost reduction in relation to system operation and maintenance by employing a wavelength variable laser light source to which any wavelength can be set. With respect to the optical transmitters of the transmitting-end node each employing the wavelength variable laser light source, it is possible to perform a wavelength allocation reconfiguration for switching light wavelengths to be used thereby so that the light wavelengths can be adapted to a traffic state.

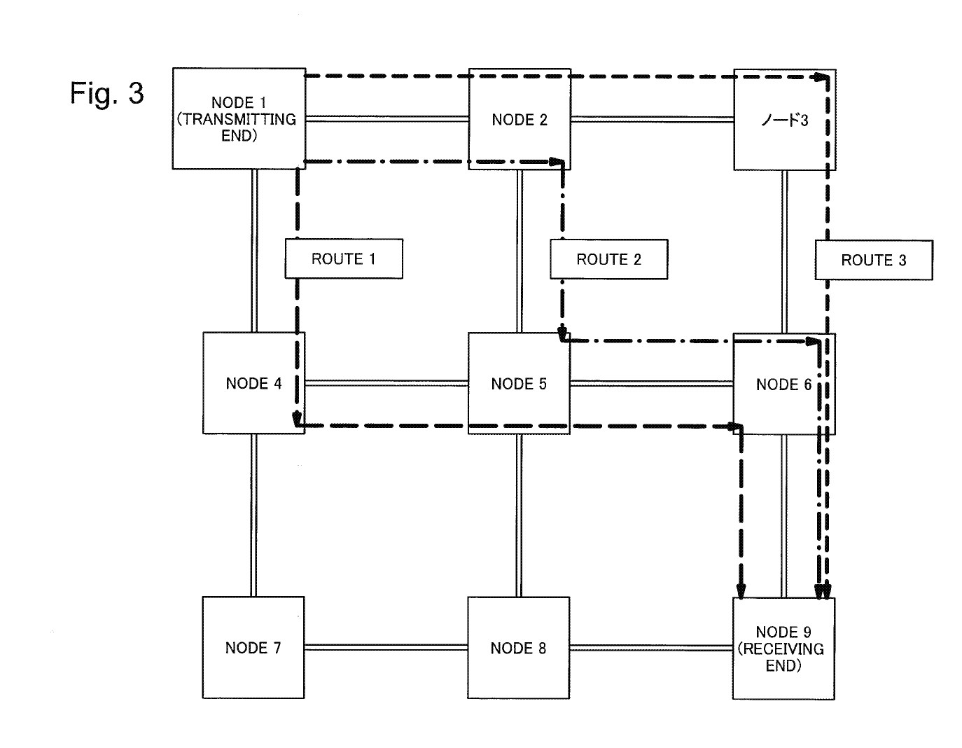

FIG. 3 illustrates a mesh network including nodes 1 to 9, for describing an example of a case where switching of light wavelengths used by the respective optical transmitters of the transmitting-end node is performed.

In the case where the node 1 and the node 9 are made a transmitting-end node and a receiving-end node, respectively, a route 1, a route 2 and a route 3 are assumed to be signal routes from the node 1 up to the node 9. All the signal routs, that is, the route 1, the route 2 and the route 3, pass through a path between the node 6 and the node 9. Thus, generally, the wavelengths of lights for use in the respective signal routes, that is, the route 1, the route 2 and the route 3, are made different from one another.

In FIG. 3, under a normal state where communication between the node 1 and the node 9 is performed by using the route 1, upon occurrence of a failure at a certain point between any two adjacent ones of the nodes 4, 5 and 6 located midway of the route 1, the mesh network changes the signal route to a different one in order to bypass the failure. For example, the mesh network changes the signal route to the route 2 or the route 3, and allows the communication to continue. At this time, the optical transmitters of the transmitting-end node switch light wavelengths which have been used for the route 1 to light wavelengths to be used for the route 2 or the route 3, respectively.

When the optical transmitters of the transmitting-end node have switched light wavelengths for the purpose of the route change in such a way as described above, naturally, digital coherent optical receivers of the receiving-end node result in receiving respective signal lights having wavelengths different from those which have been received until then.

Meanwhile, there exists a definite standard for a wavelength interval with respect to light generated by a wavelength variable laser light source. The international telecommunication union (ITU) prescribes this standard in ITU-T G.694.1 as “Spectral grids for WDM applications: DWDM frequency grid”. This recommendation prescribes that a light source having channel frequencies adjacent to 193.1 THz and are arranged at equal intervals of 12.5 GHz, 25 GHz, 50 GHz or 100 GHz is to be employed.

That is, as a result, the optical transmitters of the transmitting-side node perform switching of the wavelength of light to a wavelength corresponding to a frequency different from a frequency which has been used for the route 1 until then by at least 12.5 GHz, 25 GHz, 50 GHz or 100 GHz. This is a frequency difference which significantly exceeds a frequency difference which can be compensated by the light source frequency offset compensation circuit of each of the digital coherent optical receivers. Thus, in each of the digital coherent optical receivers of the receiving-side node, a frequency of local light generated by the local oscillation light source needs to be switched to a frequency different from that having been used for the communication via the route 1.

An optical receiver and a local light controlling method for controlling the wavelength of local light generated by a local oscillation light source for the purpose of dealing with such switching of the wavelength of signal light are disclosed in patent literature (PTL) 1. A technology disclosed in PTL 1 makes it possible to, when the wavelength of signal light has been switched, shorten a period of time necessary for wavelength sweeping in the local oscillation light source which is performed in order to cause the wavelength of the local light to coincide with that of the signal light.

An optical receiver disclosed in PTL 1 is provided with a monitor signal determination unit at the output side of a coherent receiving unit which generates an electric signal by performing opto-electric conversion processing on light which is obtained by mixing the local light outputted from the local oscillation light source and the received signal light. The monitor signal determination unit determines whether or not the electric signal is being outputted from the coherent receiving unit. Further, a local light control unit possesses a parameter control sequence which enables sweeping within a wavelength variable range of the local oscillation light source in the shortest period of time, and performs control of the wavelength of local light by sequentially changing a plurality of wavelength setting parameters in accordance with the predetermined parameter control sequence. When it has been confirmed that signal light is being inputted to the coherent receiving unit, then, the presence or absence of a monitor signal is monitored while changing the wavelength of local light in accordance with the parameter control sequence which enables the sweeping in the shortest period of time. When the wavelength of local light has been approximately matched with that of the signal light, an electric signal begins to be outputted from the coherent receiving unit, and thus, the monitor signal also begins to be detected. Upon detection of this monitor signal, the sweeping of the wavelength of local light is brought to a halt. In this way, local light whose wavelength is approximately matched with that of the signal light results in being generated from the local oscillation light source.

In addition, with respect to such a wavelength variable laser light source used in the optical transmitter and the local oscillation light source, for example, a distributed feedback (DFB) semiconductor laser array having a plurality of narrow line widths is employed. The wavelength variable laser light source selects and drives a laser corresponding to an appropriate one of wavelength channels on the basis of setting values stored in a memory unit in advance by using an electric-current control circuit and a wavelength channel switching circuit which are included in a light source apparatus. Further, a wavelength adjustment can be performed by performing temperature control of a Peltier element, or the like. An example of such a wavelength variable laser light source is disclosed in PTL 2 as a wavelength variable laser generation apparatus.

Further, there has been a polarized wave multiplexing coherent optical receiving technology in which a polarized wave multiplexing technology for transmitting and receiving a signal resulting from multiplexing two independent signals by utilizing two orthogonal polarization states of light is applied to a digital coherent optical communication technology. As compared with a coherent optical receiving technology utilizing a single polarized wave, the polarized wave multiplexing coherent optical receiving technology can make the transmission efficiency of a channel double. For example, a configuration of the polarized wave multiplexing coherent optical receiver is illustrated in FIG. 1 of PTL 3.

### CITATION LIST

### Patent Literature

[PTL 1] Japanese Unexamined Patent Application Publication No. 2010-109847
[PTL 2] Japanese Unexamined Patent Application Publication No. 2009-123985
[PTL 3] Japanese unexamined Patent Application Publication No. 2009-253972

### SUMMARY OF INVENTION

### Technical Problem

As described above, in a network employing the dense wavelength division multiplexing technology, wavelengths are switched so as to be adapted to a traffic state by using the wavelength variable laser light sources. Thus, as a result, each of the digital coherent optical receivers of the receiving-end node receives signal light having a wavelength different from that of signal light having been received until then without any prior notice, and cannot obtain any signal output unless performing switching of the wavelength of local light in conjunction with the switching of the wavelength of the received signal light.

As a technology for solving such a problem, there has been a technology disclosed in PTL 1. The technology disclosed in PTL 1 is configured so as to shorten a period of time necessary for wavelength sweeping by providing a monitor signal determination unit at the output side of a coherent receiving unit, and bringing the wavelength sweeping within a wavelength variable range, performed by a local oscillation light source, to a halt at the time when a monitor signal has been detected.

In the technology disclosed in PTL 1, however, when signal light having a different wavelength has been received without any prior notice, first, a signal output from the coherent receiving unit is brought to a halt. Further, it is necessary to provide operation steps in which the halt of the signal output is detected by the monitor signal determination unit, and then, the local oscillation light source is instructed to perform the wavelength sweeping. Subsequent thereto, the wavelength sweeping is started, and upon detection of the signal output, the wavelength sweeping is brought to a halt, so that local light whose wavelength is approximately matched with that of the signal light is generated from the local oscillation light source. Thus, there is a problem that, even if a period of time necessary for the wavelength sweeping is shortened, as a result, it actually takes time from the switching of the wavelength of signal light until completion of the switching of the wavelength of local light.

An object of the present invention is to provide a coherent optical receiver which can solve the aforementioned problem and makes it possible to, even when having received signal light having a wavelength different from that of signal light having been received until then without any prior notice, promptly switch the wavelength of local light in conjunction with the switching of the wavelength of the received signal light.

### Solution to Problem

In order to achieve the aforementioned object, a coherent optical receiver according to an aspect of the present invention includes a signal light divergence means for causing signal light to diverge to first signal light and second signal light; a local oscillation light source for generating local oscillating light (local light); an optical phase hybrid means for causing the first signal light to interfere with the local light and outputs interference light; and a wavelength detection means for receiving the second signal light, detecting a wavelength of the signal light on the basis of the second signal light and thereby controlling a wavelength of the local light generated by the local oscillation light source.

Further, a local light switching method according to another aspect of the invention includes causing signal light to diverge to first signal light inputted to an optical phase hybrid means that causes the first signal light to interfere with local oscillating light (local light) and outputs interference light, and second signal light inputted to a wavelength detection means; and, in the wavelength detection means, detecting a wavelength of the signal light on the basis of the second signal light, and performing control of a wavelength of the local light generated by the local oscillation light source.

### Advantageous Effects of Invention

According to the present invention, it is possible to, even when the wavelength of currently received signal light has switched without any prior notice, promptly switch the wavelength of local light in conjunction with the switching of the wavelength of the received signal light.

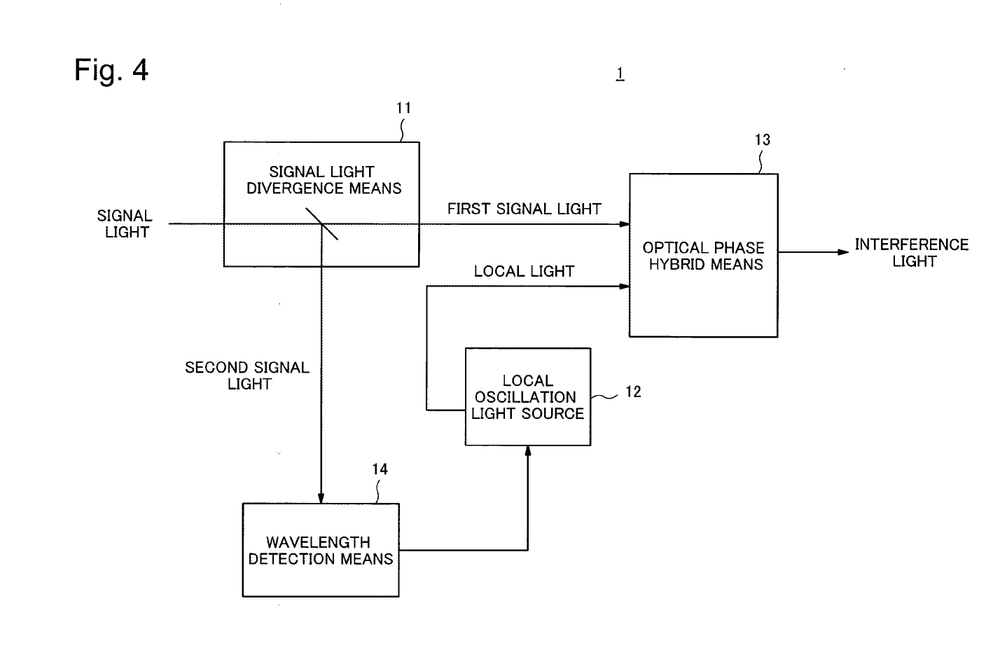

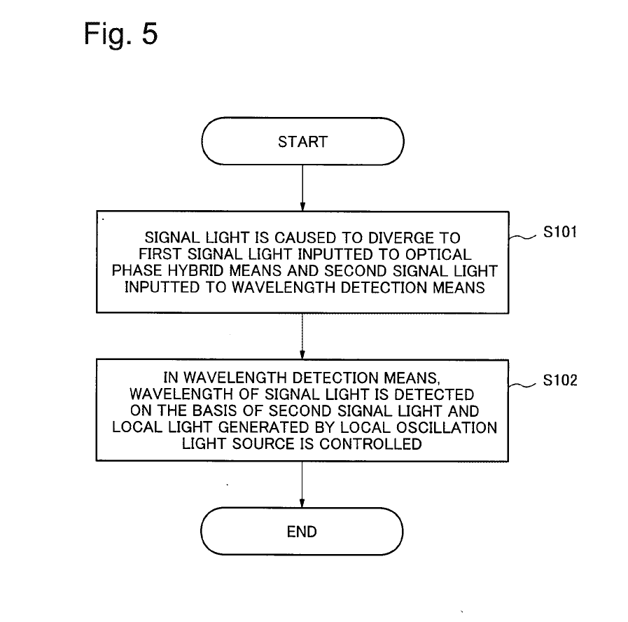

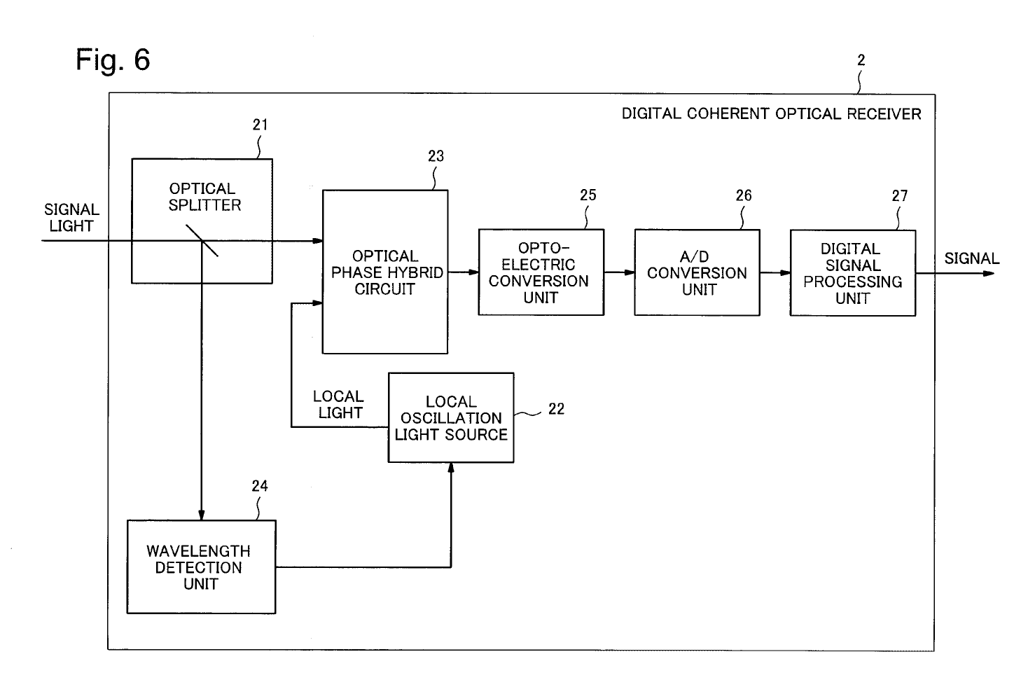

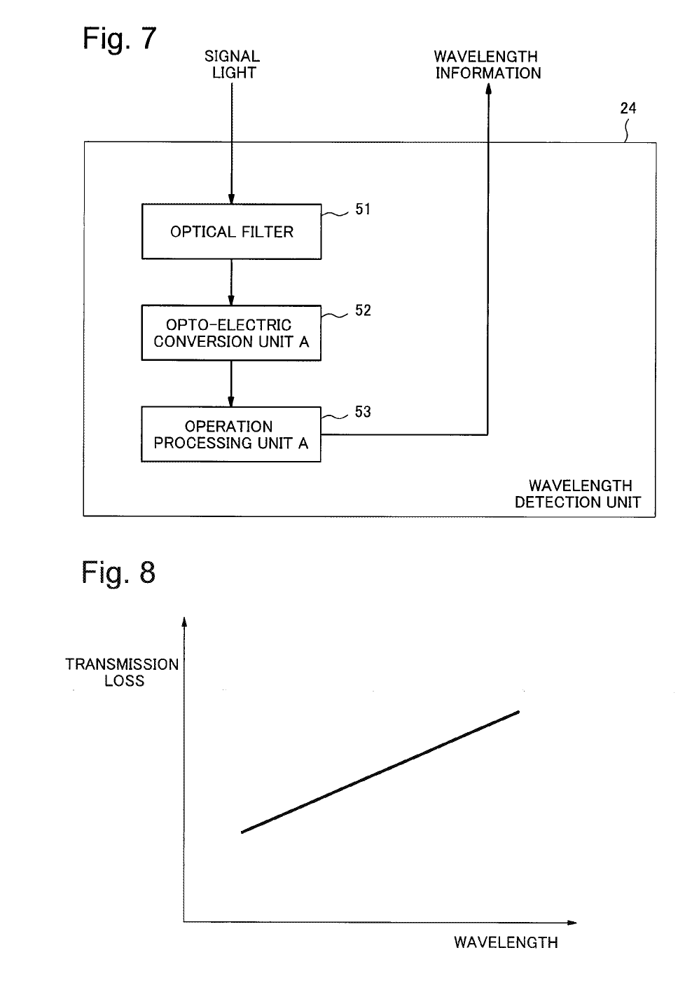

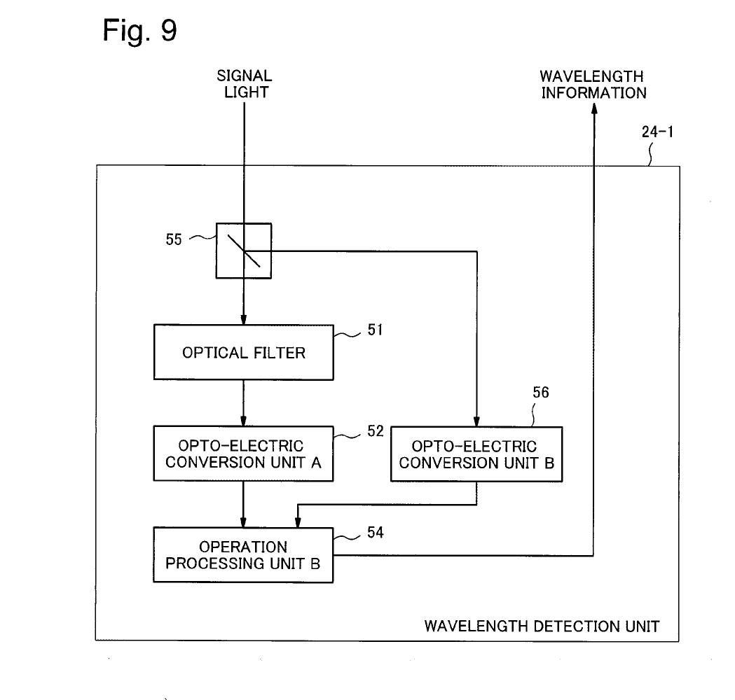

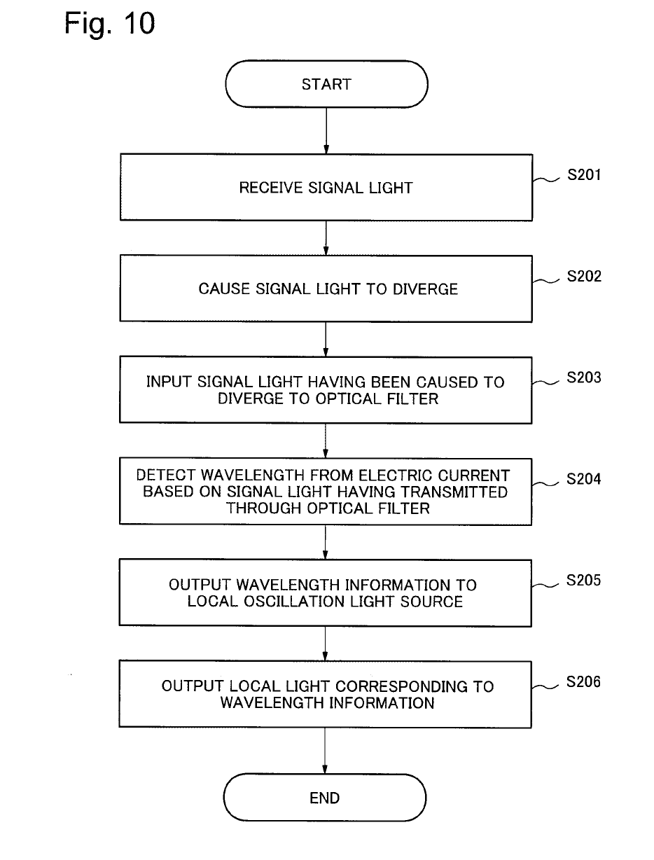

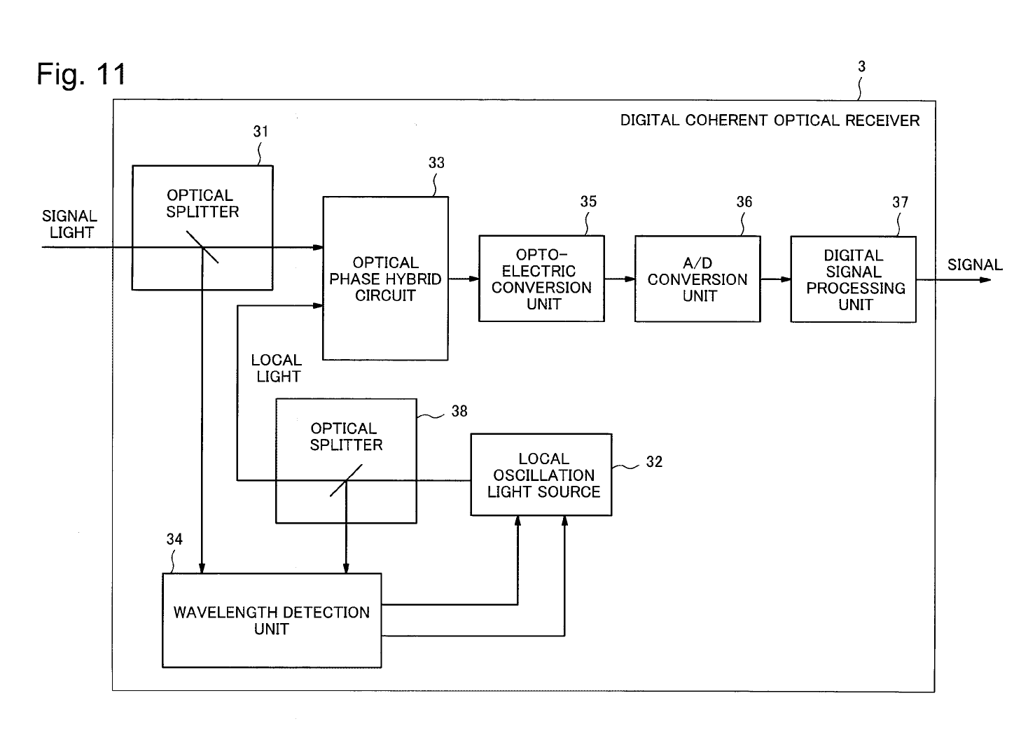

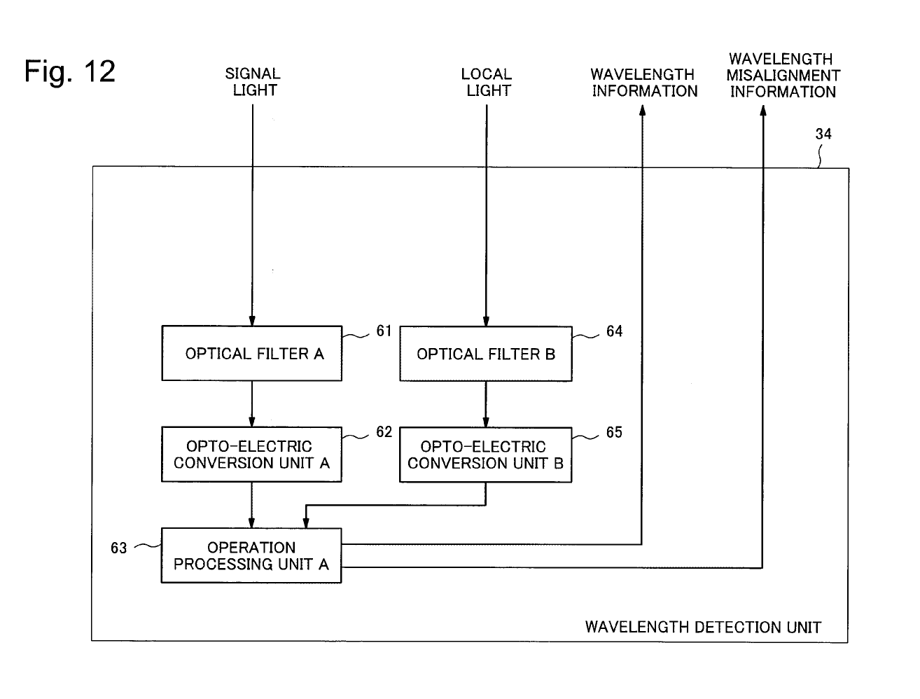

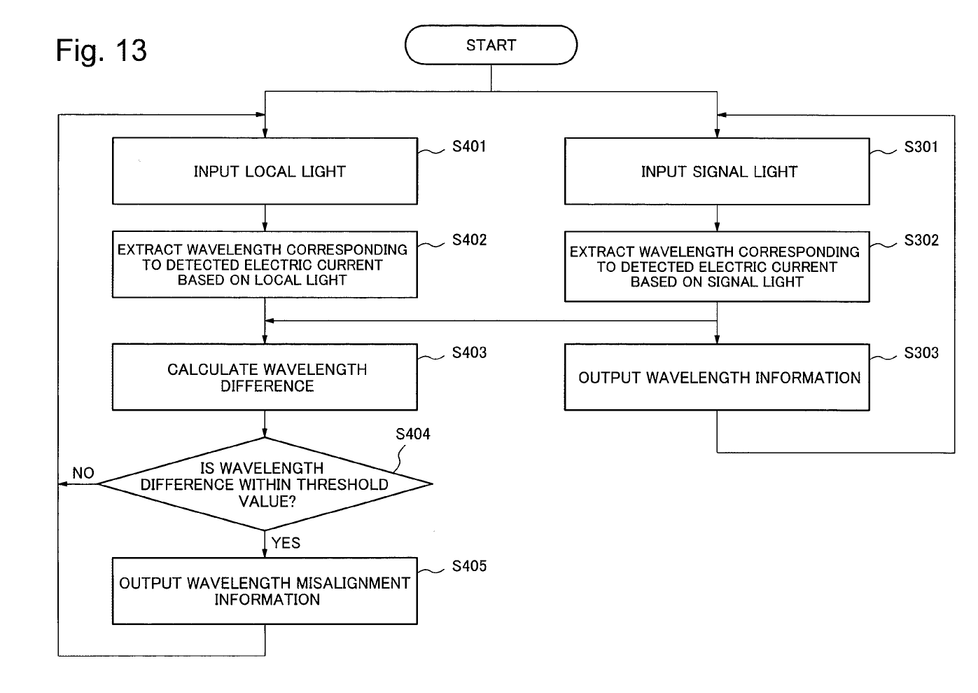

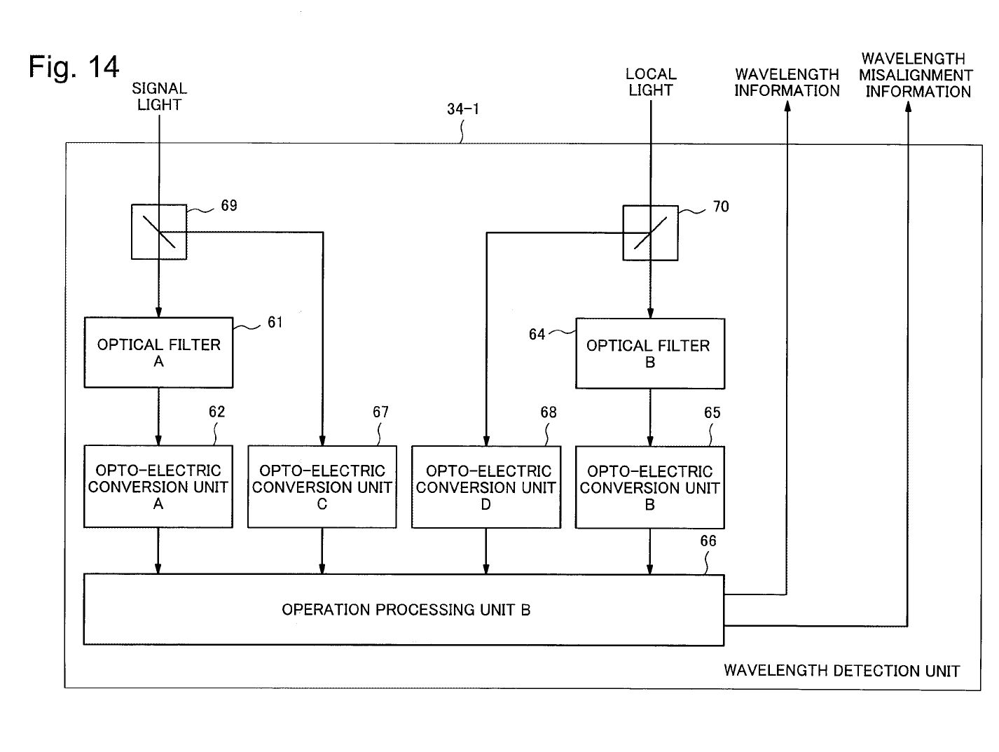

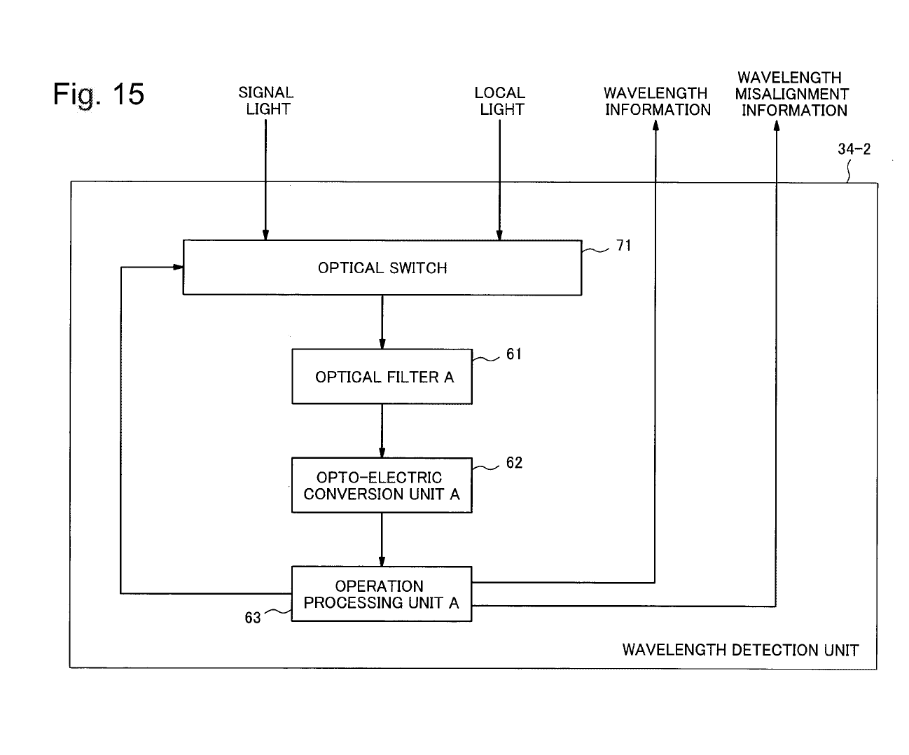

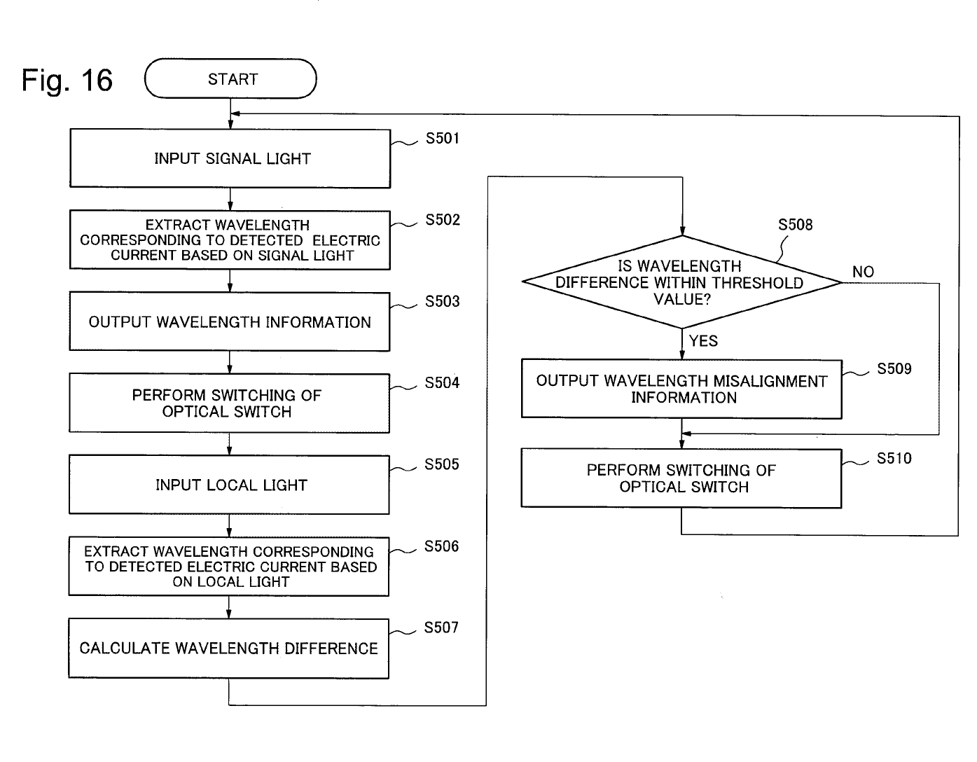

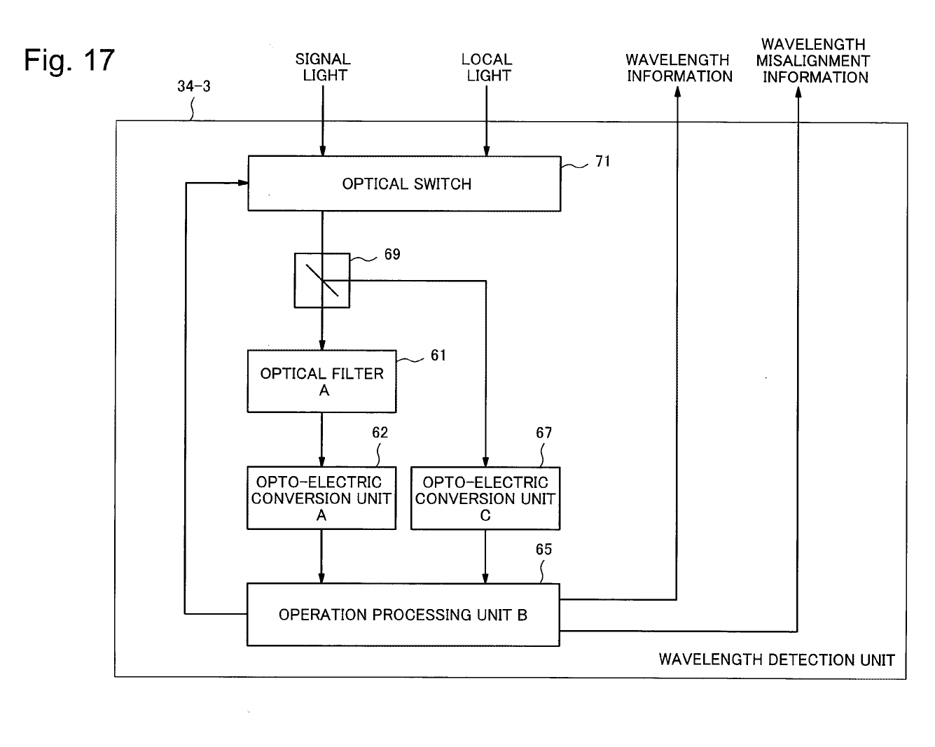

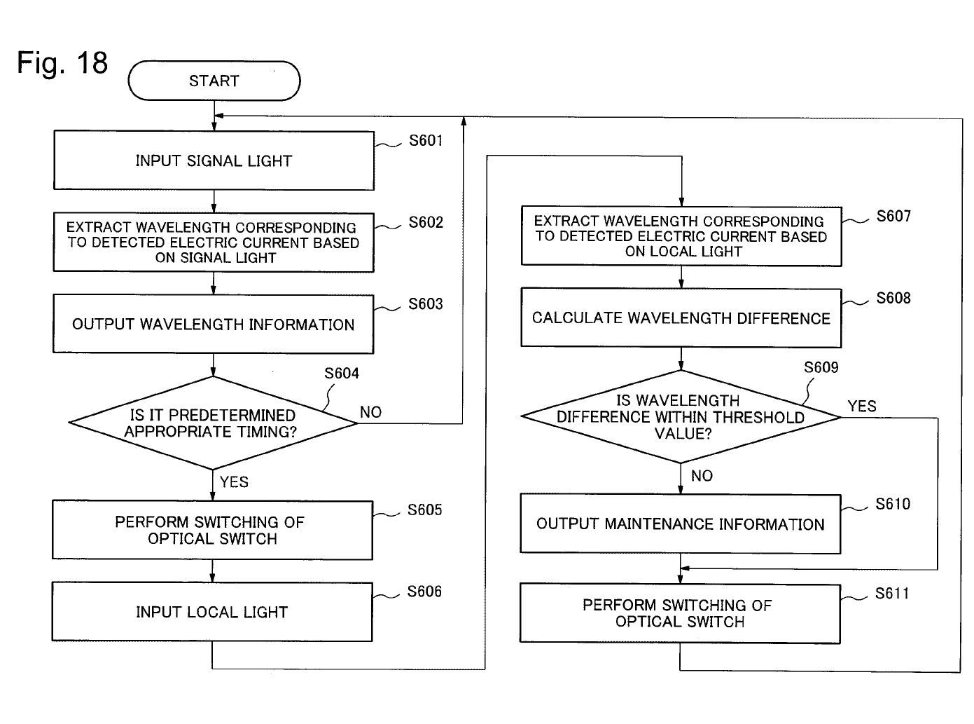

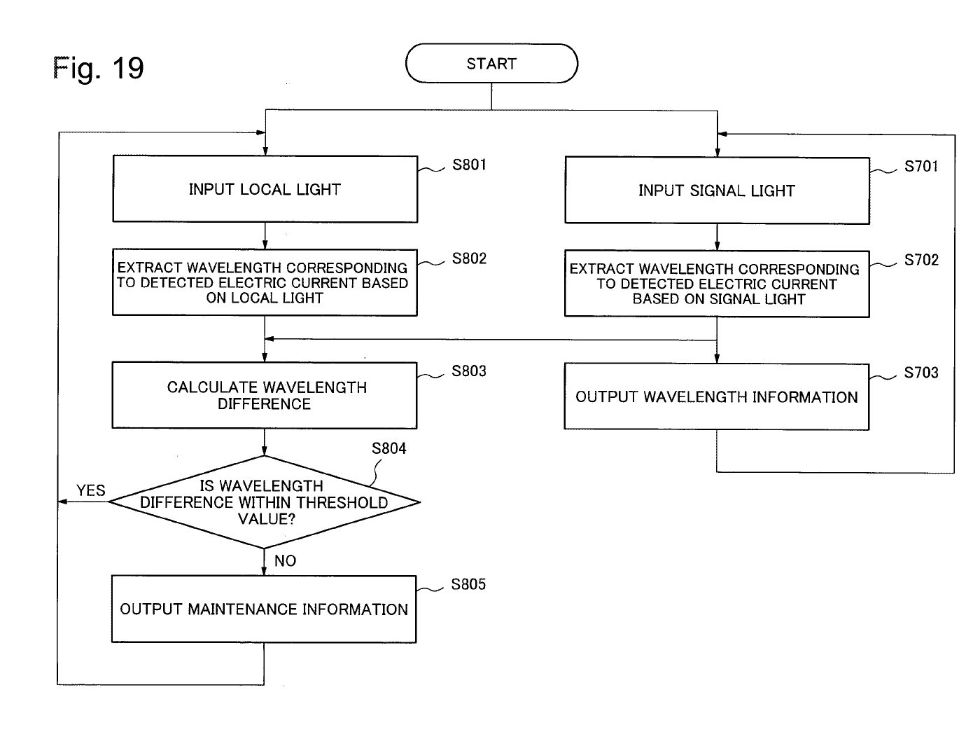

### BRIEF DESCRIPTION OF DRAWINGS

[FIG. 1] A block diagram illustrating an example of a configuration of a network employing a dense wavelength division multiplexing technology

[FIG. 2] A block diagram illustrating an example of a configuration of a digital coherent optical receiver

[FIG. 3] A block diagram illustrating a configuration of a mesh network used for describing an example of a case where switching of light wavelengths used by respective optical transmitters of a transmitting-end node is performed.

[FIG. 4] A block diagram illustrating a configuration of a coherent optical receiver according to a first exemplary embodiment

[FIG. 5] A flowchart illustrating local light switching operation according to a first exemplary embodiment

[FIG. 6] A block diagram illustrating a configuration of a digital coherent optical receiver according to a second exemplary embodiment

[FIG. 7] A block diagram illustrating an example of a configuration of a wavelength detection unit according to second exemplary embodiment

[FIG. 8] A graph illustrating an example of a wavelength dependency of an optical filter used by a wavelength detection unit

[FIG. 9] A block diagram illustrating another example of a configuration of a wavelength detection unit according to a second exemplary embodiment

[FIG. 10] A flowchart illustrating local light switching operation according to a second exemplary embodiment

[FIG. 11] A block diagram illustrating a configuration of a digital coherent optical receiver according to a third exemplary embodiment

[FIG. 12] A block diagram illustrating an example of a configuration of a wavelength detection unit according to a third exemplary embodiment

[FIG. 13] A flowchart illustrating operation of a wavelength detection unit shown in FIG. 12

[FIG. 14] A block diagram illustrating another example of a configuration of a wavelength detection unit according to a third exemplary embodiment

[FIG. 15] A block diagram illustrating still another example of a configuration of a wavelength detection unit according to a third exemplary embodiment

[FIG. 16] A flowchart illustrating operation of a wavelength detection unit shown in FIG. 15

[FIG. 17] A block diagram illustrating still another example of a configuration of a wavelength detection unit according to a third exemplary embodiment

[FIG. 18] A flowchart illustrating another example of operation of a wavelength detection unit according to a third exemplary embodiment

[FIG. 19] A flowchart illustrating still another example of operation of a wavelength detection unit according to third exemplary embodiment.

### DESCRIPTION OF EMBODIMENTS

Exemplary embodiments to practice the present invention will be described with reference to the drawings.

In addition, exemplary embodiments described below are mere exemplifications, and apparatuses and methods according to the present disclosure are not limited to the configurations of the following exemplary embodiments.

A first exemplary embodiment which is a fundamental exemplary embodiment will be described with reference to FIG. 4 and FIG. 5.

FIG. 4 is a block diagram illustrating a configuration of a coherent optical receiver according to the first exemplary embodiment of the present invention.

A coherent optical receiver 1 of the first exemplary embodiment includes a signal light divergence means 11, a local oscillation light source 12, an optical phase hybrid means 13 and a wavelength detection means 14.

The signal light divergence means 11 causes signal light to diverge to first signal light and second signal light. The local oscillation light source 12 generates local oscillating light (local light). The optical phase hybrid means 13 causes the first signal light and the local light to interfere with each other, and outputs interference light. The wavelength detection means 14 receives the second signal light, detects the wavelength of signal light on the basis of the second signal light, and controls the wavelength of the local light generated by the local oscillation light source.

FIG. 5 is a flowchart illustrating local light switching operation according to the first exemplary embodiment.

Signal light is caused to diverge to first signal light inputted to the optical phase hybrid means which causes the first signal light to interfere with local oscillating light (local light) and outputs interference light, and second signal light inputted to the wavelength detection means (S101). On the basis of the second signal light, the wavelength detection means detects the wavelength of the signal light and controls the wavelength of the local light generated by the local oscillation light source (S102).

In this way, in the first exemplary embodiment, it is possible to, even when the wavelength of currently received signal light has switched without any prior notice, promptly switch the wavelength of the local light in conjunction with the switching of the wavelength of the received signal light. This is because the wavelength detection means is configured so as to detect the wavelength of the signal light on the basis of the second signal light to which the signal light has been caused to diverge, and control the wavelength of the local light generated by the local oscillation light source.

Next, a second exemplary embodiment will be described with reference to FIGS. 6 to 10.

FIG. 6 is a block diagram illustrating a configuration of a digital coherent optical receiver according to the second exemplary embodiment.

A digital coherent optical receiver 2 includes an optical splitter 21, a local oscillation light source 22, an optical phase hybrid circuit 23, a wavelength detection unit 24, an opto-electric conversion unit 25, an A/D (analog/digital) conversion unit 26 and a digital signal processing unit 27.

The optical splitter 21 is an optical coupling system provided on a receiving path for signal light to which a signal is being applied, and causes the signal light to diverge to signal light inputted to the optical phase hybrid circuit 23 and signal light inputted to the wavelength detection unit 24. As the optical coupling system, for example, a half mirror is employed.

The local oscillation light source 22 generates local oscillating light (local light) mixed with signal light in the optical phase hybrid circuit 23. The local oscillation light source 22 is a wavelength variable laser light source, and is capable of driving a laser corresponding to any one of wavelength channels.

The optical phase hybrid circuit 23 receives signal light and local light, and causes them to interfere with each other to output interference light.

The wavelength detection unit 24 receives the diverged signal light, detects the wavelength of the received signal light and outputs wavelength information in relation to the detected wavelength to the local oscillation light source 22, thereby allowing the local oscillation light source 22 to be controlled so as to generate local light of a wavelength corresponding to the wavelength information.

The opto-electric conversion unit 25 converts the interference light outputted by the optical phase hybrid circuit 23 into an electric signal and outputs the electric signal. The A/D conversion unit 26 converts the electric signal outputted from the opto-electric conversion unit 25 into a digital signal and outputs the digital signal. The digital signal processing unit 27 receives the electric signal having been converted into a digital signal, performs signal-waveform equalization processing and demodulation processing on the electric signal, and thereby outputs a signal currently applied to the signal light.

In addition, the digital coherent optical receiver 2 is illustrated in a more simplified configuration as compared with that of the digital coherent optical receiver 100 shown in FIG. 2, but, basically, has the same configuration and function as those of the digital coherent optical receiver 100.

That is, actually, the optical phase hybrid circuit 23 outputs the I-component and the Q-component different from each other by 90 degrees in phase, but, in FIG. 6, these are shown simply. The opto-electric conversion unit 25, the A/D conversion unit 26 and the digital signal processing unit 27 also include respective configurations and functions the same as the corresponding respective configurations and functions of the opto-electric conversion circuit 112, the A/D conversion unit 120 and the digital signal processing unit 130 of the digital coherent optical receiver 100. Accordingly, the digital signal processing unit 27 is configured to, just like the digital signal processing unit 130, include a distortion equalization circuit, a light source frequency offset compensation circuit, a carrier wave phase estimation circuit, and a discrimination and determination circuit, although these components are not illustrated.

The digital coherent optical receiver 2 is configured to, unlike the digital coherent optical receiver 100, include the optical splitter 21 and the wavelength detection unit 24.

An example of the configuration of the wavelength detection unit 24 will be described with reference to FIGS. 7 to 9 below.

FIG. 7 is a block diagram illustrating an example of the configuration of the wavelength detection unit 24 according to the second exemplary embodiment.

This wavelength detection unit 24 detects the wavelength of signal light by using an optical filter 51 whose transmission loss has a wavelength dependency, an opto-electric conversion unit A 52 and an operation processing unit A 53, and outputs wavelength information for controlling the local oscillation light source 23.

FIG. 8 is a graph illustrating an example of the wavelength dependency of a transmission loss of the optical filter 51 for use in the wavelength detection unit 24. That is, light inputted to the optical filter 51 is subjected to a loss dependent on wavelength of the inputted light in the process of transmitting through the optical filter 51, and then is outputted from the optical filter 51.

The opto-electric conversion unit A 52 receives light which has transmitted through the optical filter 51, and outputs an electric-current having a value proportional to the power of the received light. The opto-electric conversion unit A 52 has an A/D converting function of A/D converting the value of the outputted electric-current, and outputting the converted value as a digital signal.

The operation processing unit A 53 has a conversion table which, on the basis of the electric-current value outputted by the opto-electric conversion unit A 52, enables identification of a light wavelength corresponding to the electric-current value. Further, from the electric-current value outputted by the opto-electric conversion unit A 52, the operation processing unit A 53 detects a light wavelength corresponding to the electric-current value by referring to the conversion table, and outputs wavelength information in relation to the detected light wavelength.

This conversion table possessed by the operation processing unit A 53 is intended to enable a light wavelength to be uniquely detected from the outputted electric-current value. That is, the conversion table used in this configuration example is created so as to take into consideration all of the loss of a transmission line, the characteristics of the opto-electric conversion unit A 52 and the wavelength dependency of the optical filter 51. Accordingly, the wavelength detection unit 24 in this configuration example is suitable for use in a network for which, via whichever one of routes signal light is transmitted, the signal light is subjected to a uniform transmission loss, and further, the value of the transmission loss is known, or a network for which the transmission loss of any of transmission lines can be ignored.

As described above, the wavelength detection unit 24 is configured to receive signal light having been caused to diverge by the optical splitter 21, and detect a light wavelength from an electric-current having a value proportional to the power of light resulting from the signal light's operation of transmitting through the optical filter 51. Thus, even when the wavelength of the signal light has switched without any prior notice, as long as the signal light is received, wavelength information adapted to the change of the wavelength can be promptly outputted.

Another example of the configuration of the wavelength detection unit will be described below.

FIG. 9 is a block diagram illustrating another example of the configuration of the wavelength detection unit according to the second exemplary embodiment.

This wavelength detection unit 24-1 includes the optical filter 51 whose transmission loss has a wavelength dependency, and the opto-electric conversion unit A 52, and further includes an operation processing unit B 54, an optical splitter 55 which causes received signal light to diverge, and an opto-electric conversion unit B 56.

The operation processing unit B 54 stores the characteristic data shown in FIG. 8, in relation to a wavelength dependency, and is configured to calculate a transmission loss to which the signal light having transmitted through the optical filter 51 is subjected from the optical filter, and obtain a wavelength corresponding to the transmission loss.

That is, the operation processing unit B 54 calculates a transmission loss to which signal light has been subjected by transmitting through the optical filter 51 from the ratio of an electric-current output value of the opto-electric conversion unit B 56 and an electric-current output value of the opto-electric conversion unit A 52. Further, the operation processing unit B 54 detects a wavelength from the characteristic data shown in FIG. 8, in relation to the wavelength dependency, by performing processing for obtaining a wavelength corresponding to the calculated transmission loss, and outputs wavelength information related to the detected wavelength.

This wavelength detection unit 24-1 is configured so as to, unlike the wavelength detection unit 24, obtain only a transmission loss to which the signal light has been subjected by transmitting through the optical filter 51. Thus, this configuration is suitable for use in a network whose transmission loss of signal light through transmission lines cannot be ignored, and further, which subjects the signal light different transmission loss depending on the transmission line.

Incidentally, it has been described above that the processing performed by the operation processing unit B 54 is such that the transmission loss is calculated on the basis of the ratio of electric-current values obtained by allowing the respective opto-electric conversion units to convert light before passing through the optical filter 51 and light after passing through the optical filter 51, and more specifically, this processing is configured as described below.

That is, the opto-electric conversion unit A 56 and the opto-electric conversion unit B 52 perform electric-current conversions of light before passing through the optical filter 51 and light after passing through the optical filter 51, respectively, and further, perform electric-current to voltage conversions of electric-current values to output voltage values, respectively. The operation processing unit B 54 converts the respective voltage values into light power values (dB), obtains a transmittance of the optical filter 51 by calculating the ratio of the two dB values and calculates a transmission loss corresponding to the transmittance.

Further, configuration may be made such that the operation processing unit B 54 detects a transmittance of the optical filter 51 from a difference between the voltage values outputted by the respective opto-electric conversion units described above. In this case, the operation processing unit B 54 is provided with a correspondence table which enables a transmittance of the optical filter 51 to be detected from a difference between the voltage values outputted by the respective opto-electric conversion units, obtains the transmittance of the optical filter 51 on the basis of the correspondence table and calculates a transmission loss corresponding to the transmittance.

In this specification, such a configuration as that of this wavelength detection unit 24-1 is called a configuration which, on the basis of difference information in relation to the power of light after transmitting through an optical filter and the power of light before transmitting through the optical filter, allows detection of the wavelength of the light.

As described above, the wavelength detection unit 24-1 is configured to detect the wavelength of inputted signal light from a transmission loss to which the inputted signal light has been subjected by transmitting through the optical filter 51. Thus, even when the wavelength of signal light has switched without any prior notice, as long as the signal light is received, wavelength information adapted to the change of wavelength of the signal light can be promptly outputted.

Here, the wavelength information outputted by the wavelength detection unit may be a numerical value itself of the detected wavelength. Further, the wavelength information may be identification information corresponding to the wavelength. For example, the wavelength information may be information which can be identified as a frequency grid prescribed in ITU-T G.694.1.

That is, the wavelength detection unit controls the wavelength of local light generated by the local oscillation light source by outputting the wavelength information to the local oscillation light source which is a wavelength variable laser light source. In the local oscillation light source, for example, a plurality of semiconductor laser arrays is provided, and through the operations of an electric-current control circuit and a wavelength channel switching circuit which constitute a light source apparatus, a laser corresponding a wavelength channel specific to inputted wavelength information is selected and driven on the basis of setting values stored in a memory unit in advance.

Switching operation of local light according to the second exemplary embodiment having such a configuration as described above will be described below.

FIG. 10 is a flowchart illustrating local light switching operation according to the second exemplary embodiment.

Signal light to which a signal is applied has been received (S201). The received signal light is caused to diverge to signal light inputted to an optical phase hybrid circuit and signal light inputted to a wavelength detection unit (S202). Signal light having been inputted to the wavelength detection unit is inputted to an optical filter whose transmission loss has a wavelength dependency (S203). The signal light's wavelength corresponding to the optical filter's output having been converted into an electric signal is detected on the basis of information in relation to the wavelength dependency (S204). Wavelength information in relation to the detected wavelength is outputted to a local oscillation light source that generates local light (S205). Local light having a wavelength corresponding to the wavelength information is generated by the local oscillation light source (S206).

As described above, even when the wavelength of currently received signal light has switched without any prior notice, the digital coherent optical receiver according to the second exemplary embodiment can promptly switch the wavelength of local light in conjunction with the switching of the wavelength of the received signal light. This is because the wavelength detection unit is configured to so as to detect the wavelength of the signal light on the basis of the signal light having been caused to diverge, and output wavelength information for controlling the wavelength of the local light generated by the local oscillation light source. The wavelength detection unit is configured to so as to detect the wavelength of the signal light on the basis of a transmission loss to which the signal light has been subjected by transmitting through the optical filter having a wavelength dependency, and output the wavelength information corresponding to the detected wavelength to the local oscillation light source.

Next, a third exemplary embodiment will be described with reference to FIGS. 11 to 17 below.

FIG. 11 is a block diagram illustrating a configuration of a digital coherent optical receiver according to the third exemplary embodiment.

A digital coherent optical receiver 3 includes an optical splitter 31, a local oscillation light source 32, an optical phase hybrid circuit 33, a wavelength detection unit 34, an opto-electric conversion unit 35, an A/D conversion unit 36, a digital signal processing unit 37 and an optical splitter 38.

The digital coherent optical receiver 3 is different from the digital coherent optical receiver 2 of the second exemplary embodiment in the respect that the digital coherent optical receiver 3 includes the optical splitter 38 for causing local light generated by the local oscillation light source 32 to diverge to two paths. The optical splitter 38, which is an optical coupling system provided on a path via which local light is inputted to the optical phase hybrid circuit 33, causes the local light to diverge to local light inputted to the optical phase hybrid circuit 33 and local light inputted to the wavelength detection unit 34, and outputs the diverged local lights. With respect to the optical splitter 38, just like the optical splitter 31, for example, a half mirror is employed.

Further, the components of the digital coherent optical receiver 3 other than the optical splitter 38 and the wavelength detection unit 34 are the same as those of the digital coherent optical receiver 2 of the second exemplary embodiment. That is, the optical splitter 31, the local oscillation light source 32, the optical phase hybrid circuit 33, the opto-electric conversion unit 35, the A/D conversion unit 36 and the digital signal processing unit 37 each have the same configuration and function as those of the corresponding component of the digital coherent optical receiver 2. Accordingly, although the digital coherent optical receiver 3 is illustrated in a more simplified configuration as compared with that of the digital coherent optical receiver 100 shown in FIG. 2, basically, the digital coherent optical receiver 3 has the same configuration and function as those of the digital coherent optical receiver 100.

The digital coherent optical receiver 3 is different from in the case of the second exemplary embodiment in the respect that the digital coherent optical receiver 3 is configured such that the signal light and the local light which have been caused to diverge are inputted to the wavelength detection unit 34, and in addition to the wavelength information in relation to the signal light, wavelength misalignment information in relation to the signal light and the local light is also outputted from the wavelength detection unit 34.

Accordingly, in the digital coherent optical receiver 3 of the third exemplary embodiment, in the local oscillation light source 32, the wavelength information outputted from the wavelength detection unit 34 is used for wavelength switching of the local light, and the wavelength misalignment information is used for a frequency offset adjustment.

As having been described in the background art, in a digital coherent optical receiver, since the frequency of signal light and that of local light are merely roughly matched with each other with a frequency difference of several GHz, frequency offset compensation processing in a digital signal processing unit needs to be performed. The digital coherent optical receiver 3 of the third exemplary embodiment is configured so as to enable the local oscillation light source to perform a frequency offset adjustment in this frequency offset compensation processing.

With respect to a wavelength variable laser light source for use in the local oscillation light source 32, for example, a plurality of semiconductor laser arrays are employed. Further, a laser corresponding to any one of wavelength channels is selected and driven on the basis of setting values stored in a memory unit in advance by an electric-current control circuit and a wavelength channel switching circuit. Accordingly, the local oscillation light source 32 generates light, as the local light, having a wavelength corresponding to, for example, a frequency grid prescribed in ITU-T G.694.1, on the basis of the wavelength information outputted from the wavelength detection unit 34. Further, since the wavelength variable laser light source is capable of performing a wavelength adjustment by performing temperature control of a Peltier element, or the like, the local oscillation light source 32 adjusts the wavelength of the local light on the basis of the wavelength misalignment information outputted from the wavelength detection unit 34.

Several examples of the configuration of the wavelength detection unit will be described below with reference to FIGS. 12 to 17.

FIG. 12 is a block diagram illustrating an example of the configuration of the wavelength detection unit according to the third exemplary embodiment.

This wavelength detection unit 34 is configured to, just like the wavelength detection unit 24 having been described with reference to FIG. 7, use an optical filter, an opto-electric conversion unit and an operation processing unit for each of signal light and local light. A transmission loss of the optical filter has a wavelength dependency shown in FIG. 8.

The wavelength detection unit 34 uses an optical filter A 61 and an opto-electric conversion unit A 62 for the signal light, and uses an optical filter B 64 and an opto-electric conversion unit B 65 for the local light. Further, the operation processing unit A 63 has a conversion table which, on the basis of an electric-current value outputted by the opto-electric conversion unit A 62, enables identification of the signal light's wavelength corresponding to the electric-current value outputted from the opto-electric conversion unit A 62. Similarly, the operation processing unit A 63 has a conversion table which, on the basis of an electric-current value outputted by the opto-electric conversion unit B 65, enables identification of the local light's wavelength corresponding to the electric-current value outputted from the opto-electric conversion unit A 62.

Incidentally, the opto-electric conversion unit A 62 and the opto-electric conversion unit B 65 output electric-currents proportional to the powers of the lights which have been received through their operations of transmitting through the optical filter A 61 and the optical filter B 64, and have A/D conversion functions of A/D converting the electric-currents and outputting the electric-currents as digital signals, respectively.

The conversion table included in the operation processing unit A 63 is intended to enable a light wavelength to be uniquely detected from a value of the outputted electric-current. That is, the conversion table used for identifying the wavelength of the signal light is created so as to take into consideration all of the loss of any of transmission lines, the characteristic of the opto-electric conversion unit A 52 and the wavelength dependency of the optical filter A 61. Further, the conversion table used for identifying the wavelength of the local light is created so as to take into consideration the characteristic of the opto-electric conversion unit B 65 and the wavelength dependency of the optical filter B 64.

This wavelength detection unit 34 is suitable for use in a network for which via whichever one of routes signal light is transmitted, the signal light is subjected to a uniform transmission loss, and further, the value of the transmission loss is known, or a network for which the loss of any of transmission lines can be ignored, just like the wavelength detection unit 24 of the digital coherent optical receiver 2.

As described above, the operation processing unit A 63 is capable of detecting the wavelength of the signal light from the electric-current value outputted from the opto-electric conversion unit A 62, and is capable of detecting the wavelength of the local light from the electric-current value outputted from the opto-electric conversion unit B 65.

FIG. 13 is a flowchart illustrating operation of the wavelength detection unit 34 shown in FIG. 12.

Since the signal light and the local light are independently inputted to the wavelength detection unit 34, and electric-current values are independently inputted to the operation processing unit A 63 from the opto-electric conversion unit A 62 and the opto-electric conversion unit B 65, independent task processes are performed in the operation processing unit A 63, respectively.

First, operation for signal light will be described below.

When signal light has been inputted to the wavelength detection unit 34 (S301), the opto-electric conversion unit A 62 outputs an electric-current value corresponding to the power of the signal light which has been attenuated, depending on the wavelength of the signal light, by transmitting through the optical filter A 61. The operation processing unit A 63 identifies a light wavelength corresponding to the electric-current value having been outputted by the opto-electric conversion unit A 62 on the basis of the conversion table stored in the operation processing unit A 63 in advance, and extracts the wavelength of the signal light (S302). The operation processing unit A 63 outputs wavelength information in relation to the wavelength of the signal light to the local oscillation light source 32 (S303). The above-described operation is repeated as long as the signal light is being inputted.

Operation for local light will be described below.

When local light has been inputted to the wavelength detection unit 34 (S401), the opto-electric conversion unit B 65 outputs an electric-current value corresponding to the power of the local light which has been attenuated, depending on the wavelength of the local light, by transmitting through the optical filter B 64. The operation processing unit A 63 identifies a light wavelength corresponding to the electric-current value having been outputted by the opto-electric conversion unit B 65 on the basis of the conversion table stored in the operation processing unit A 63 in advance, and extracts the wavelength of the local light (S402). The operation processing unit A 63 calculates a wavelength difference from the wavelength of the signal light extracted in S302 and the wavelength of the local light extracted in S402 (S403). It is confirmed whether or not the calculated wavelength difference falls within a predetermined threshold value (S404).

This threshold value should be a value corresponding to frequency difference of several GHz which the value can be deemed as a frequency offset of the digital coherent optical receiver.

Further, in the case where the wavelength difference falls within the predetermined threshold value, the operation processing unit A 63 outputs the wavelength difference to the local oscillation light source 32 as wavelength misalignment information in relation to the signal light and the local light (S405). In the case where the wavelength difference exceeds the predetermined threshold value, the operation processing unit A 63 does not output the wavelength misalignment information until the wavelength difference falls within the threshold value. When the wavelength of the signal light has switched without any prior notice and has shifted from the wavelength of the local light to a great degree, since such wavelength misalignment information is meaningless, the operation processing unit A 63 does not output any wavelength misalignment information until completion of the switching of the wavelength of the local light in conjunction with the switching of the wavelength of the signal light.

The wavelength detection unit 34 repeats the above-described operation as long as the local light is being inputted.

As described above, the wavelength detection unit 34 detects the wavelength of the signal light on the basis of the signal light having been caused to diverge by the optical splitter 31. Thus, it is possible to, even when the wavelength of the signal light has switched without any prior notice, promptly wavelength information adapted to the switched wavelength of the signal light to the local oscillation light source 32. Further, the wavelength detection unit 34 is also provided with a configuration which allows detection of the wavelength of the local light on the basis of the local light having been caused to diverge by the optical splitter 38. Thus, it is possible to calculate an amount of wavelength misalignment between the signal light and the local light, and output information related to the wavelength misalignment to the local oscillation light source 32. The local oscillation light source 32 can switch an oscillation wavelength of the local light on the basis of the wavelength information and can adjust a frequency offset on the basis of the wavelength misalignment information.

Here, the wavelength information may be a numerical value itself of the detected wavelength. Further, the wavelength information may be identification information corresponding to the wavelength thereof. For example, the wavelength information may be information which can be identified as a frequency grid prescribed in ITU-T G.694.1.

Another example of the configuration of the wavelength detection unit will be described below.

FIG. 14 is a block diagram illustrating another example of the configuration of the wavelength detection unit according to the third exemplary embodiment.

This wavelength detection unit 34-1 is provided with the same configuration as that of the wavelength detection unit 24-1 shown in FIG. 9 for each of signal light and local light.

The wavelength detection unit 34-1 uses, for the signal light, an optical filter A 61, an opto-electric conversion unit A 62 and an opto-electric conversion unit C 67, and uses, for the local light, an optical filter B 64, an opto-electric conversion unit B 65 and an opto-electric conversion unit D 68. That is, the opto-electric conversion unit C 67 performs an opto-electric conversion of signal light having been caused to diverge by the optical splitter 69 without passing this signal light through the optical filter A 61, and outputs an electric signal. Similarly, the opto-electric conversion unit D 68 performs an opto-electric conversion of local light having been caused to diverge by the optical splitter 70 without passing this local light through the optical filter B 64, and outputs an electric signal.

The optical filter A 61 and the optical filter B 64 are an optical filter having a wavelength dependency, respectively shown in FIG. 8, with respect to a transmission loss.

The operation processing unit B 66 of the wavelength detection unit 34-1 stores therein characteristic data in relation to a wavelength dependency of each of the optical filters, and for each of the optical filters, on the basis of the characteristic data, obtains a light wavelength corresponding to a transmission loss of light having transmitted through the optical filter.

That is, the operation processing unit B 66 calculates a transmission loss to which the signal light has been subjected by transmitting through the optical filter A 61, from the ratio of an electric-current value outputted from the opto-electric conversion unit C 67 and an electric-current value outputted from the opto-electric conversion unit A 62. Further, the operation processing unit B 66 obtains the signal light's wavelength corresponding to the calculated transmission loss from the stored characteristic data in relation to the wavelength dependency of the optical filter A 61. Similarly, the operation processing unit B 66 calculates a transmission loss to which the local light has been subjected by transmitting through the optical filter B 64, from the ratio of an electric-current value outputted from the opto-electric conversion unit D 68 and an electric-current value outputted from the opto-electric conversion unit B 65. Further, the operation processing unit B 66 obtains the local light's wavelength corresponding to the calculated transmission loss from the stored characteristic data in relation to the wavelength dependency of the optical filter B 64.

The wavelength detection unit 34-1 can obtain the respective wavelengths of the signal light and the local light in such a way as described above, and thus, outputs wavelength information in relation to the signal light and wavelength misalignment information in relation to the signal light and the local light by performing the same operation as that shown in FIG. 13.

Further, the wavelength detection unit 34-1 obtains the wavelength of the signal light by calculating only a transmission loss to which the signal light has been subjected by transmitting through the optical filter A 61. Similarly, the wavelength detection unit 34-1 obtains the wavelength of the local light by calculating only a transmission loss to which the local light has been subjected by transmitting through the optical filter B 64. Thus, the wavelength detection unit 34-1 is suitable for use in a network for which a transmission loss of signal light through any of transmission lines cannot be ignored, and further, the signal light is subjected to a transmission loss which differs depending on a transmission line via which the signal light is transmitted.

Incidentally, it has been described above that the processing performed by the operation processing unit B 66 is such that the transmission loss is calculated on the basis of the ratio of electric-current values obtained by allowing the respective opto-electric conversion units to convert light before passing through the optical filter and light after passing through the optical filter, and more specifically, this processing is performed as described below.

That is, the opto-electric conversion units perform electric-current conversions of lights, and further, perform electric-current to voltage conversions of the electric-current values to output voltage values, respectively. The operation processing unit B 66 converts the respective voltage values into light power values (dB), obtains a transmittance of the optical filter by calculating the ratio of the two dB values, and calculates a transmission loss corresponding to the obtained transmittance.

Further, the operation processing unit B 66 may detect the transmittance of the optical filter from a difference between the above-described voltage values outputted by the respective opto-electric conversion units. In this case, the operation processing unit B 66 is provided with a correspondence table which enables a transmittance of the optical filter to be detected from a difference between the voltage values outputted by the respective opto-electric conversion units, and obtains the transmittance of the optical filter on the basis of the correspondence table to calculate a transmission loss corresponding to the obtained transmittance.

In this specification, such a configuration as that of this wavelength detection unit 34-1 is called a configuration which, on the basis of difference information in relation to the power of light after transmitting through an optical filter and the power of light before transmitting through the optical filter, allows detection of the wavelength of the light.

As described above, the wavelength detection unit 34-1 detects the wavelength of the signal light on the basis of the signal light having been caused to diverge by the optical splitter 31. Thus, it is possible to, even when the wavelength of the signal light has switched without any prior notice, promptly output wavelength information adapted to the switched wavelength of the signal light to the local oscillation light source 32. Further, the wavelength detection unit 34-1 is also provided with a configuration which allows detection of the wavelength of the local light on the basis of the local light having been caused to diverge by the optical splitter 38. Thus, it is possible to calculate an amount of wavelength misalignment in relation to the signal light and the local light and to output information related to the wavelength misalignment to the local oscillation light source 32. The local oscillation light source 32 can switch an oscillation wavelength of the local light on the basis of the wavelength information, and can adjust a frequency offset on the basis of the wavelength misalignment information.

Still another example of the configuration of the wavelength detection unit will be described below.

FIG. 15 is a block diagram illustrating still another example of the wavelength detection unit according to the third exemplary embodiment.

This wavelength detection unit 34-2 provided with an optical switch 71 selects any one of signal light and local light which are inputted to the wavelength detection unit 34-2 itself by using the optical switch 71 and processes the selected light. That is, the wavelength detection unit 34-2 alternately selects the signal light and the local light by using the optical switch 71, and detects a wavelength of the selected one of the signal light and the local light by using the optical filter A 61 whose transmission loss has a wavelength dependency, the opto-electric conversion unit A 62 and the operation processing unit A 63. Further, the operation processing unit A 63 is provided with a conversion table which, on the basis of an electric-current value outputted by the opto-electric conversion unit A 62, enables identification of a light wavelength corresponding to the electric-current value and detects a wavelength from the electric-current value outputted from the opto-electric conversion unit A 62.

This wavelength detection unit 34-2 is configured so as to integrate the configuration of the wavelength detection unit 34 shown in FIG. 12 by using the optical switch 71. Accordingly, just like the wavelength detection unit 24 of the digital coherent optical receiver 2, the wavelength detection unit 34-2 is suitable for use in a network for which, via whichever one of routes signal light is transmitted, the signal light is subjected to a uniform transmission loss, and further, the value of the transmission loss is known, or a network for which the loss of any of transmission lines can be ignored.

Incidentally, the optical switch 71 performs switching for selection of light to be inputted on the basis of an instruction from the operation processing unit A 63. That is, the operation processing unit A 63 already recognizes which one of the signal light and the local light the light having been selected by the optical light 71 is, and thus, the operation processing unit A 63 can discriminate which one of the signal light and the local light the detected wavelength corresponds to. Thus, the operation processing unit A 63 can properly use the above-described conversion table provided for the signal light and a conversion table provided for the local light. Further, the operation processing unit A 63 calculates wavelength misalignment in relation to the signal light and the local light from the detected wavelength of the signal light and wavelength of the local light, and outputs wavelength information in relation to the signal light and wavelength misalignment information in relation to the signal light and the local light.

FIG. 16 is a flowchart illustrating operation of the wavelength detection unit 34-2 shown in FIG. 15.

The optical switch 71 selects and outputs signal light in the initial state. When signal light has been inputted to the wavelength detection unit 34-2 (S501), the opto-electric conversion unit A 62 outputs an electric-current value corresponding to the power of the signal light which has been attenuated depending on the wavelength of the signal light by transmitting through the optical filter A 61. The operation processing unit A 63 identifies a light wavelength corresponding to the electric-current value having been outputted by the opto-electric conversion unit A 62 on the basis of the conversion table for signal light stored in the operation processing unit A 63 in advance and extracts the wavelength of the signal light (S502). The operation processing unit A 63 outputs wavelength information in relation to the wavelength of the signal light to the local oscillation light source 32 (S503). The operation processing unit A 63 switches the selection of the optical switch 71 from the signal light to the local light (S504).

The operation processing unit A 63 already recognizes that the selection of the optical switch 71 is switched to the local light, and thus, can discriminate that a light wavelength corresponding to the electric-current value having been outputted by the opto-electric conversion unit A 62 is the wavelength of the local light.

When local light has been inputted (S505), the opto-electric conversion unit A 62 outputs an electric-current value corresponding to the power of the local light which has been attenuated depending on the wavelength of the local light by transmitting through the optical filter A 61. The operation processing unit A 63 identifies a light wavelength corresponding to the electric-current value having been outputted by the opto-electric conversion unit A 62 on the basis of the conversion table for local light stored in the operation processing unit A 63 in advance and extracts the wavelength of the local light (S506).

The operation processing unit A 63 calculates a wavelength difference from the wavelength of signal light having been extracted in S502, and the wavelength of local light having been extracted in S506 (S507). Further, the operation processing unit A 63 confirms whether or not the calculated wavelength difference falls within a predetermined threshold value (S508).

This threshold value should be a value corresponding to frequency difference of several GHz which can be deemed as a frequency offset value for the digital coherent optical receiver.

Further, in the case where the wavelength difference falls within the predetermined threshold value, the operation processing unit A 63 outputs the wavelength difference to the local oscillation light source 32 as wavelength misalignment information in relation to the signal light and the local light (S509). In the case where the wavelength difference exceeds the predetermined threshold value, the operation processing unit A 63 does not output wavelength misalignment information. This is because, when the wavelength of the signal light has switched without any prior notice and has shifted from the wavelength of the local light to a great degree, it is meaningless to output such wavelength misalignment information. Further, even after the switching of the signal light without any prior notice, when the wavelength of the local light has switched in the local oscillation light source on the basis of the wavelength information in relation to the signal light having been outputted in S503, the result of the determination in S508 becomes YES, so that the wavelength misalignment information begins to be outputted.

The operation processing unit A 63 returns the selection of the optical switch 71 back to the signal light side (S510), and the above-described operation is repeated.

As described above, the wavelength detection unit 34-2 detects the wavelength of the signal light on the basis of the signal light having been caused to diverge by the optical splitter 31. Thus, even when the wavelength of the signal light has switched without any prior notice, wavelength information adapted to the switched wavelength of the signal light can be promptly outputted to the local oscillation light source 32. Further, the wavelength detection unit 34-2 is also provided with a configuration which allows detection of the wavelength of the local light on the basis of the local light having been caused to diverge by the optical splitter 38. Thus, it is possible to calculate an amount of wavelength misalignment in relation to the signal light and the local light, and output information related to the amount of wavelength misalignment to the local oscillation light source 32. The local oscillation light source 32 can switch an oscillation wavelength of the local light on the basis of the wavelength information and can adjust a frequency offset on the basis of the wavelength alignment information.

Yet another example of the configuration of the wavelength detection unit will be described below.

FIG. 17 is a block diagram illustrating yet another example of the configuration of the wavelength detection unit according to the third exemplary embodiment.

The configuration of this wavelength detection unit 34-3 is the same as that of the wavelength detection unit 34-2 shown in FIG. 15 in the respect that the optical switch 71 is provided and thereby either signal light or local light which are inputted to the wavelength detection unit 34-3 is selected and processed. Further, a configuration in which the wavelength detection unit 34-3 alternately selects the signal light and the local light by using the optical switch 71 and detects the wavelength of selected one of the signal light and the optical light is the same as the configuration of the wavelength detection unit 24-1 shown in FIG. 9.

That is, the wavelength detection unit 34-3 alternately selects the signal light and the local light by using the optical switch 71, and detects a wavelength by using the optical filter A 61, the opto-electric conversion unit A 62 and the opto-electric conversion unit C 67 with respect to selected one of the signal light and the local light (selected light).

The opto-electric conversion unit A 62 performs an opto-electric conversion of the selected light having passed through the optical filter A 61, and outputs an electric signal. Further, the opto-electric conversion unit C 67 performs an opto-electric conversion of the selected light having been caused to diverge by the optical splitter 69 without passing the selected light through the optical filter A 61, and outputs an electric signal. The optical filter A 61 is an optical filter having a wavelength dependency, shown in FIG. 8, with respect to a transmission loss.

The operation processing unit B 65 stores therein characteristic data in relation to the wavelength dependency of the optical filter A 61, and is configured to obtain a wavelength of the selected light on the basis of a transmission loss to which the selected light having transmitted through the optical filter A 61 has been subjected.

That is, the operation processing unit B 65 calculates a transmission loss to which the selected light has been subjected by transmitting through the optical filter A 61 from the ratio of an electric-current value outputted from the opto-electric conversion unit C 67 and an electric-current value outputted from the opto-electric conversion unit A 62. Further, the selected light's wavelength corresponding to the calculated transmission loss is obtained from the stored characteristic data in relation to the wavelength dependency. Further, the operation processing unit B 65 switches the optical switch 71 so as to allow the signal light and the local light to become the selected light alternately and detects the wavelengths of the respective signal light and local light.

The wavelength detection unit 34-3 can obtain the wavelengths of the respective signal light and local light in this way, and thus, outputs wavelength information in relation to the signal light and wavelength misalignment information in relation to the signal light and the local light by performing the same operation as shown in FIG. 16.

Incidentally, it has been described above that the processing performed by the operation processing unit B 65 is such that the transmission loss is calculated on the basis of the ratio of electric-current values obtained by allowing the respective opto-electric conversion units to convert light before passing through the optical filter and light after passing through the optical filter, and more specifically, this processing is performed as described below.

That is, the opto-electric conversion units perform electric-current conversions of received lights, and further, perform electric-current to voltage conversions of the electric-current values to output voltage values, respectively. The operation processing unit B 65 converts the respective voltage values into light power values (dB), obtains a transmittance of the optical filter by calculating the ratio of the two dB values, and calculates a transmission loss corresponding to the transmittance.

Further, the operation processing unit B 65 may detect the transmittance of the optical filter from a difference between the above-described voltage values outputted by the respective opto-electric conversion units. In this case, the operation processing unit B 65 is provided with a correspondence table which enables a transmittance of the optical filter to be detected from a difference between the voltage values outputted by the respective opto-electric conversion units, obtains a transmittance of the optical filter on the basis of the correspondence table and calculates a transmission loss corresponding to the transmittance.

In this specification, such a configuration as that of this wavelength detection unit 34-3 is called a configuration which, on the basis of difference information in relation to a difference between the power of light after transmitting through an optical filter and the power of light before transmitting through the optical filter, allows detection of the wavelength of the light.

As described above, the wavelength detection unit 34-3 detects the wavelength of the signal light on the basis of the signal light having been caused to diverge by the optical splitter 31. Thus, even when the wavelength of the signal light has switched without any prior notice, wavelength information adapted to the switched wavelength of the signal light can be promptly outputted to the local oscillation light source 32. Further, the wavelength detection unit 34-3 is also provided with a configuration which allows detection of the wavelength of the local light on the basis of the local light having been caused to diverge by the optical splitter 38. Thus, it is possible to calculate an amount of wavelength misalignment in relation to the signal light and the local light, and output information related to the wavelength misalignment to the local oscillation light source 32. The local oscillation light source 32 can switch an oscillation wavelength of the local light on the basis of the wavelength information, and can adjust a frequency offset on the basis of the wavelength misalignment information.

Further, the wavelength detection unit 34-3 integrates the configuration of the wavelength detection unit 34-1 shown in FIG. 12 by using the optical switch 71. Accordingly, the wavelength detection unit 34-3 is suitable for use in a network whose transmission loss of signal light through transmission lines cannot be ignored, and further, which subjects the signal light different transmission loss depending on the transmission line.

As described above, even when the wavelength of currently received signal light has switched without any prior notice, the digital coherent optical receiver of the third exemplary embodiment can promptly switch the wavelength of local light in conjunction with the switching of the wavelength of the received signal light. This is because the wavelength detection unit detects the wavelength of the signal light on the basis of the signal light having been caused to diverge, and outputs wavelength information for controlling the wavelength of the local light generated by the local oscillation light source. The wavelength detection unit detects the wavelength of the signal light on the basis of a transmission loss to which the signal light has been subjected when having transmitted through the optical filter having a wavelength dependency, and outputs the wavelength information corresponding to the detected wavelength to the local oscillation light source.

Further, the digital coherent optical receiver of the third exemplary embodiment can adjust wavelength misalignment between the currently received signal light and the local light in the local oscillation light source. This is because the wavelength detection unit outputs wavelength misalignment information in relation to the signal light and the local light which enables the local oscillation light source to perform a wavelength-misalignment adjustment for the local light. The wavelength detection unit detects the wavelength of the signal light on the basis of the signal light having been caused to diverge detects the wavelength of the local light on the basis of the local light having similarly been caused to diverge, and outputs the wavelength misalignment information in relation to the signal light and the local light.

A modification example 1 of the third exemplary embodiment will be described below.

A digital coherent optical receiver in the modification example 1 of the third exemplary embodiment has the same configuration as that of the digital coherent optical receiver 3 shown in FIG. 11. Further, the wavelength detection unit has the same configuration as that of the wavelength detection unit 34-2 shown in FIG. 15 or that of the wavelength detection unit 34-3 shown in FIG. 17.

The digital coherent optical receiver in the modification example 1 of the third exemplary embodiment is the same as in the case of the third exemplary embodiment in the respect that, when the wavelength of currently received signal light has switched without any prior notice, the wavelength of local light is promptly switched in conjunction with the switching of the wavelength of the received signal light. Nevertheless, the digital coherent optical receiver in the modification example 1 of the third exemplary embodiment outputs, not the wavelength misalignment information in relation to the signal light and the local light, but maintenance information in relation to the wavelength of the local light, from the wavelength detection unit.

FIG. 18 is a flowchart illustrating another example of the operation of the wavelength detection unit according to the third exemplary embodiment.

This wavelength detection unit usually selects signal light by using the optical switch, and outputs wavelength information related to the signal light. Further, the wavelength detection unit discriminates a wavelength difference between the signal light and the local light by switching the optical switch to the local light side at given timing. When the wavelength difference falls within a predetermined threshold value, a current state is determined to be normal, and the wavelength detection unit does not take any action; while, when the wavelength difference exceeds the predetermined threshold value, the current state is determined to be abnormal, and the wavelength detection unit outputs predetermined maintenance information.

Referring to FIG. 18, operations of S601, S602 and S603 are the same as the operations of S501, S502 and S503 shown in FIG. 16, respectively.

The wavelength detection unit switches the optical switch to the local light side at predetermined appropriate timing (S604 and S605). This timing may be once per several seconds or once per several minutes. As described below, this timing should be determined according to for what purpose the maintenance information is outputted. Further, in the process of S604, it is confirmed whether or not the wavelength of the signal light having been extracted in S602 is the same as the wavelength thereof having been extracted during operation in an immediately previous cycle. This process is performed in order to confirm that a current state is in a state where any wavelength switching operation for the signal light is not performed.

Operations of S606, S607 and S608 subsequent thereto are the same as the operations of S505, S506 and S507 shown in FIG. 16, respectively.

In S609, the wavelength detection unit confirms whether or not a wavelength difference between the signal light and the local light having been calculated in S608 falls within a predetermined appropriate threshold value. In the case where the wavelength difference falls within the predetermined threshold value (YES in S609), a current state is determined to be normal, and the wavelength detection unit does not take any action. In the case where the wavelength difference exceeds the predetermined threshold value (NO in S609), a current state is determined to be abnormal, so that the maintenance information is outputted (S610).

Incidentally, here, the predetermined threshold value may be appropriately set in view of what meaning a value of the wavelength difference between the signal light and the local light having been calculated in S608 has. That is, the threshold value should be determined according to what kind of abnormal state is to be identified this process is aimed at. For example, in the case where a state, in which the occurrence of a frequency offset exceeding a range within which any frequency offset can be compensated by a frequency offset compensation circuit of the digital signal processing unit, is to be identified, a wavelength difference value corresponding to a limit of frequency offsets which can be compensated should be set as the threshold value. Further, even for wavelength differences of frequency offsets which can be compensated, when obtaining, for example, information related to a case where a wavelength difference among the wavelength differences has exceeded 50 percentage of a limit value of the frequency offsets or information related to a case where a wavelength difference among the wavelength differences has exceeded 80 percentage of the limit value of the frequency offsets, a wavelength difference value corresponding to each of such excess determination ratios should be set as the threshold value.

In addition, the outputted maintenance information in relation to the wavelength of the local light may be only information which means that a wavelength difference between the signal light and the local light has exceeded a preset threshold value, or may be information resulting from appending the calculated wavelength difference to the above information. Further, this maintenance information may be outputted to only the local oscillation light source, or, besides, may be also outputted to a monitoring apparatus (not illustrated). For example, processing may be performed such that, when it has been identified a case where a wavelength difference between the signal light and the local light has exceeded a limit of frequency offsets which can be compensated by a frequency offset compensation circuit, information related to the calculated wavelength difference is outputted to the local oscillation light source, and in the local oscillation light source, the oscillation wavelength of the local light is adjusted. Further, as another example, processing may be performed such that even for wavelength differences of frequency offsets which can be compensated, when it has been identified a case where a wavelength difference among the wavelength values has exceeded a certain range of the limit value of the frequency offsets, information for notifying this excess is outputted to a monitoring apparatus (not illustrated), and is collected as reliability data in relation to the local oscillation light source.

When the above-described operation has been completed, the wavelength detection unit causes the optical switch to switch to the signal light side (S611).

Although, in the flowchart shown in FIG. 18, a wavelength difference between the signal light and the local light is calculated in S608 and the wavelength difference is compared with a threshold value range in S609, operation may be performed such that the processes of these S608 and S609 are deleted. In this case, as maintenance information to be outputted in S610, information indicating the wavelength of the local light, which has been extracted in S608, may be outputted to the local oscillation light source just as it is. In the case where such a configuration has been made, the local oscillation light source can receive monitor information related to the wavelength of the local light generated by the local oscillation light source itself from the wavelength detection unit. Thus, the local oscillation light source can determine the propriety of the wavelength of currently oscillating local light in the local oscillation light source itself, and can perform appropriate control thereof as needed.

A modification example 2, in which, just like in the modification example 1 of the third exemplary embodiment, appropriate maintenance information in relation to local light can be obtained, will be described below.

A digital coherent optical receiver in the modification example 2 of the third exemplary embodiment has the same configuration as that of the digital coherent optical receiver 3 shown in FIG. 11. Further, a wavelength detection unit has the same configuration as that of the wavelength detection unit 34 shown in FIG. 12 or that of the wavelength detection unit 34-1 shown in FIG. 14.

The digital coherent optical receiver in the modification example 2 of the third exemplary embodiment applies control based on the same viewpoint as that of the modification example 1 to the wavelength detection unit 34 shown in FIG. 12 or the wavelength detection unit 34-1 shown in FIG. 14. In the case of the modification example 1, constantly inputted signal light is switched to the local light side at appropriate timing points by using the optical switch to identify the wavelength of the local light; while this modification example 2 is different from the modification example 1 only in the respect that the identification of the wavelength of the signal light and the identification of the wavelength of the local light are always concurrently performed. Accordingly, detailed description of the modification example 2 is omitted here.

FIG. 19 is a flowchart illustrating still another example of the operation of the wavelength detection unit according to the third exemplary embodiment. A flowchart corresponding to this flowchart shown in FIG. 19 is shown in FIG. 13.

This wavelength detection unit constantly receives signal light and local light, and outputs wavelength information in relation to the signal light and appropriate maintenance information in relation to the local light. As the appropriate maintenance information in relation to the local light in this case, maintenance information which determines that the current status is abnormal is outputted when the wavelength difference exceeds a predetermined threshold value, as having been described with reference to FIG. 18.

Referring to a FIG. 19, processes of S701 to S703 for the signal light is the same as those of S301 to S303 shown in FIG. 13. Nevertheless, processing is performed such that, in the process of S702, it is confirmed whether or not the wavelength of the signal light having been extracted in S702 is the same as the wavelength of the signal light having been extracted during an immediately previous cycle, and in the case where the result of the determination is true, information in relation to the extracted wavelength is outputted to the process of S803. This is because a process of calculating a difference with the local light is caused to perform only under the state where the switching of the wavelength of the signal light is not performed. Further, in the process of S803, when the information in relation to the wavelength of the signal light has been interrupted, error information is outputted.

In S804, the wavelength detection unit confirms whether or not the wavelength difference between the signal light and the local light which has been calculated in S803 falls within a predetermined appropriate threshold value. In the case where the wavelength difference falls within the predetermined threshold value (YES in S804), the wavelength detection unit determines that a current state is normal, and does not take any action. In the case where the wavelength difference exceeds the predetermined threshold value (NO in S804), the wavelength detection unit determines that a current state is abnormal, and outputs the maintenance information (S805).

Incidentally, although not illustrated, the presence or absence of the above-described error information is also determined in S804. Further, when the error information has been outputted in the process of S803, processing forwarding through a route of YES in S804 is performed.

The predetermined threshold value used in S804 may be appropriately set in view of what meaning a value indicating the wavelength difference between the signal light and the local light has, just like in the description of the modification example 1.

Further, just like in the modification example 1, in the flowchart shown in FIG. 19, the processes of S803 and S804 may be deleted, and information indicating the wavelength of the local light having been extracted in S802 may be outputted to the local oscillation light source just as it is, as the maintenance information to be outputted in S805. In this case, naturally, information in relation to the wavelength of the signal light having been extracted in S702 does not need to be sent to the process of S803.

As described above, in the digital coherent optical receiver in each of the modification examples 1 and 2 of the third exemplary embodiment, it is possible to, when the wavelength of currently received signal light has switched without any prior notice, the wavelength of local light is promptly switched in conjunction with the switching of the wavelength of the received signal light. Further, the digital coherent optical receiver in each of the modification examples 1 and 2 of the third exemplary embodiment can obtain appropriate maintenance information in relation to the wavelength of the local light.

Incidentally, the digital coherent optical receiver of each of the aforementioned the first to the third exemplary embodiments may be a polarized wave multiplexing coherent optical receiver for receiving polarized wave multiplexed optical signal light in which two independent signals are multiplexed on respective two orthogonally polarized waves of light.

Hereinbefore, the present invention has been described with reference to exemplary embodiments, but it is to be noted that the present invention is not limited to the aforementioned exemplary embodiments. The configuration and details of the present invention may be subjected to various modifications understandable by those skilled in the art within a scope not departing the gist of the present invention.

This application is based upon and claims the benefit of priority from Japanese Patent Application No. 2011-106391, filed on May 11, 2011, the disclosure of which is incorporated herein in its entirety by reference.

Further, the aforementioned exemplary embodiments may be partially or as a whole summarized in the following supplementary notes, although not limited the supplementary notes.

(Supplementary Note 1) A coherent optical receiver including signal light divergence means for causing signal light to diverge to first signal light and second signal light; a local oscillation light source for generating local oscillating light (local light); optical phase hybrid means for causing the first signal light to interfere with the local light and outputting an interference light; and wavelength detection means for receiving the second signal light, detecting a wavelength of the signal light on the basis of the second signal light, and thereby controlling a wavelength of the local light generated by the local oscillation light source.

(Supplementary Note 2) The coherent optical receiver according to supplementary note 1, wherein the wavelength detection means detects a wavelength of inputted light on the basis of a power of light after transmitting through an optical filter whose transmission loss has a wavelength dependency.

(Supplementary Note 3) The coherent optical receiver according to supplementary note 1 or 2, including local light divergence means for causing the local light to diverge to first local light inputted to the optical phase hybrid means and second local light inputted to the wavelength detection means, wherein the wavelength detection means detects an optical power of the second local light, and thereby detects an output of the local oscillation light source.

(Supplementary Note 4) The coherent optical receiver according to supplementary note 3, wherein the wavelength detection means detects a wavelength of the local light on the basis of the second local light, detects wavelength misalignment information in relation to the signal light and the local light, and thereby controls the wavelength of the local light generated by the local oscillation light source.

(Supplementary Note 5) The coherent optical receiver according to supplementary note 2, wherein the wavelength detection means includes: an optical splitter for causing the second signal light to diverge to first divergence light and second divergence light; a first opto-electric conversion unit for outputting a first electric signal corresponding to a power of the first divergence light after transmitting through the optical filter; a second opto-electric conversion unit for outputting a second electric signal corresponding to a power of the second divergence light which does not transmit through the optical filter; and an operation processing unit for calculating a difference between the first electric signal and the second electric signal, and detecting a wavelength of the second signal light on the basis of a correspondence table representing a correspondence between the difference and a wavelength suffering the transmission loss corresponding to the difference is given.

(Supplementary Note 6) The coherent optical receiver according to supplementary note 4, wherein the wavelength detection means includes: an optical switch for selecting and outputting either the second signal light or the second local light inputted to the optical switch; an optical splitter for causing the light selected and outputted by the optical switch to diverge to first divergence light and second divergence light; a first opto-electric conversion unit for outputting a first electric signal corresponding to a power of the first divergence signal after transmitting through the optical filter; a second opto-electric conversion unit for outputting a second electric signal corresponding to a power of the second divergence signal which does not transmit through the optical filter; and an operation processing unit for calculating a difference between the first electric signal and the second electric signal, detecting a wavelength of the light selected and outputted by the optical switch on the basis of a correspondence table representing a correspondence between the difference and a wavelength suffering the transmission loss corresponding to the difference is given, detecting a wavelength of the second signal light and a wavelength of the second local light by switching a selection of the optical switch to respective ones of the second signal light and the second local light, and outputting wavelength misalignment information in relation to the signal light and the local light.

(Supplementary Note 7) The coherent optical receiver according to any one of supplementary notes 1 to 6, further including an opto-electric conversion means for performing an opto-electric conversion of the interference light outputted by the optical phase hybrid means and outputting an electric signal; an A/D conversion unit for converting the electric signal into a digital signal and outputting the digital signal; and a digital signal processing unit for receiving the electric signal currently converted into the digital signal, performing signal-waveform equalization processing and demodulation processing on the received electric signal, and thereby outputting a signal currently applied to the signal light.

(Supplementary Note 8) The coherent optical receiver according to supplementary note 2, wherein the wavelength detection means includes: an optical splitter for causing inputted light to diverge to first input light and second input light; and an operation processing unit for detecting a wavelength of the inputted light on the basis of information related to a difference between a power of the first input light after transmitting through the optical filter and a power of the second input light which does not transmit through the optical filter.

(Supplementary Note 9) The coherent optical receiver according to supplementary note 2, including local light divergence means for causing the local light to diverge to first local light inputted to the optical phase hybrid means, and second local light inputted to the wavelength detection unit, wherein the wavelength detection means includes an optical switch for selecting either the inputted second signal light or second local light and outputs selected light, and an operation processing unit for detecting a wavelength of light selected and outputted by the optical switch on the basis of an outputted electric signal corresponding to a power of light after transmitting through the optical filter, detecting a wavelength of the second signal light and a wavelength of the second local light by switching a selection of the optical switch to the second signal light or the second local light, and outputting wavelength misalignment information in relation to the signal light and the local light.

(Supplementary Note 10) The coherent optical receiver according to any one of supplementary notes 4, 6 and 9, wherein the wavelength detection means outputs maintenance information in relation to wavelength misalignment regarding the signal light and the local light on the basis of the detected wavelength of the signal light and the detected wavelength of the local light.

(Supplementary Note 11) A local light switching method including: causing signal light to diverge to first signal light and second signal light, the first signal light being inputted to optical phase hybrid means that causes the first signal light to interfere with local oscillating light (local light) and outputs interference light, the second signal light being inputted to wavelength detection means; and in the wavelength detection means, detecting a wavelength of the signal light on the basis of the second signal light, and performing control of a wavelength of the local light generated by the local oscillation light source.

(Supplementary Note 12) The local light switching method according to supplementary note 11, including: inputting the light having been inputted to the wavelength detection means to an optical filter whose transmission loss has a wavelength dependency; and detecting a wavelength of the light having been inputted to the wavelength detection means on the basis of a power of the light after transmitting through the optical filter.

(Supplementary Note 13) The coherent optical receiving method according to supplementary note 11 or supplementary note 12, causing the local light to diverge to first local light inputted to the optical phase hybrid means and second local light inputted to the wavelength detection means, and detecting an output of the local oscillation light source by detecting a power of the second local light having been inputted to the wavelength detection means.

(Supplementary Note 14) The coherent optical receiving method according to supplementary note 13, including: detecting a wavelength of the local light on the basis of the second local light having been inputted to the wavelength detection means; detecting wavelength misalignment information in relation to the signal light and the local light; and controlling the wavelength of the local light generated by the local oscillation light source.

(Supplementary Note 15) The coherent optical receiving method according to supplementary note 12, including: causing to diverge the light having been inputted to the wavelength detection means to first input light and second input light; and detecting a wavelength of the inputted light on the basis of difference information related to a difference between a power of the first input light after transmitting through the optical filter and a power of the second input light which does not transmit through the optical filter.

(Supplementary Note 16) The local light switching method according to supplementary note 12, including: causing the light having been inputted to the wavelength detection means to diverge to first divergence light and second divergence light; calculating a difference between a first electric signal corresponding to a power of the first divergence light after transmitting through the optical filter and a second electric signal corresponding to a power of the second divergence light which does not transmit though the optical filter; and detecting a wavelength of the light having been inputted to the wavelength detection means on the basis of a correspondence table representing a correspondence between the difference and a wavelength from which the equalizing loss corresponding to the difference is given.

(Supplementary Note 17) The coherent optical receiving method according to supplementary note 14, including: outputting selected light resulting from selecting any one of the second signal light and the second local light which have been inputted to the wavelength detection means; causing the selected light to diverge to first divergence light and second divergence light; calculating a difference between a first electric signal corresponding to a power of the first divergence light after transmitting through the optical light and a second electric signal corresponding to a power of the second divergence light which does not transmit through the optical light; detecting a wavelength of the selected light on the basis of a correspondence table representing a correspondence between the difference and a wavelength from which the transmission loss corresponding to the difference is given; detecting a wavelength of the second signal light and a wavelength of the second local light by switching a selection of the selected light to respective ones of the second signal light and the second local light; and outputting wavelength misalignment information in relation to the signal light and the local light.

(Supplementary Note 18) The local light switching method according to supplementary note 12, including: causing the local light to diverge to first local light inputted to the optical phase hybrid means and second local light inputted to the wavelength detection means; outputting selected light resulting from selecting any one of the second signal light and the second local light which have been inputted to the wavelength detection means; detecting a wavelength of the selected light on the basis of an outputted electric signal corresponding to a power of light after transmitting through the optical filter; detecting a wavelength of the second signal light and a wavelength of the second local light by switching the selected light to respective ones of the second signal light and the second local light; and outputting wavelength misalignment information in relation to the signal light and the local light.

(Supplementary Note 19) The coherent optical receiving method according to any one of supplementary note 14, 17 and 18, including: outputting maintenance information in relation to wavelength misalignment in relation to the signal light and the local light on the basis of the wavelength of the signal light and the wavelength of the local light, the wavelengths being detected by the wavelength detection means.

### REFERENCE SIGNS LIST

1 Coherent optical receiver
2, 3 and 100 Digital coherent optical receiver
11 Signal light divergence means
12, 22, 32 and 113 Local oscillation light source
13 Optical phase hybrid means
14 Wavelength detection means
21, 31, 38, 55, 69 and 70 Optical splitter
23, 33 and 111 Optical phase hybrid circuit
24, 24-1, 34, 34-1 and 34-2 Wavelength detection unit
25 and 35 Opto-electric conversion unit
26, 36 and 120 A/D conversion unit
27, 37 and 130 Digital signal processing unit
51 Optical filter
52 and 62 Opto-electric conversion unit A
53 and 63 Operation processing unit A
54 and 66 Operation processing unit B
56 and 65 Opto-electric conversion unit B
61 Optical filter A
64 Optical filter B
67 Opto-electric conversion unit C
68 Opto-electric conversion unit D
71 Optical switch
10, 20, 30 and 40 Node
110 Coherent receiving unit
112 Opto-electric conversion circuit
121 A/D converter
131 Distortion equalization circuit
132 Light source frequency offset compensation circuit
133 Carrier wave phase estimation circuit
134 Discrimination and determination circuit
140 Optical demultiplexer
400 Optical transmitter
410 Optical multiplexer

1. A coherent optical receiver comprising:
a signal light divergence unit that causes signal light to diverge to first signal light and second signal light;
a local oscillation light source that generates local oscillating light (local light);
an optical phase hybrid unit that causes the first signal light to interfere with the local light and outputting an interference light; and
a wavelength detection unit that receives the second signal light, detects a wavelength of the signal light on the basis of the second signal light, and thereby controls a wavelength of the local light generated by the local oscillation light source.

2. The coherent optical receiver according to claim 1, wherein the wavelength detection unit detects a wavelength of inputted light on the basis of a power of light after transmitting through an optical filter whose transmission loss has a wavelength dependency.

3. The coherent optical receiver according to claim 1, comprising:
local light divergence unit that causes the local light to diverge to first local light inputted to the optical phase hybrid unit and second local light inputted to the wavelength detection unit,
wherein the wavelength detection unit detects an optical power of the second local light, and thereby detects an output of the local oscillation light source.

4. The coherent optical receiver according to claim 3, wherein the wavelength detection unit detects a wavelength of the local light on the basis of the second local light, detects wavelength misalignment information in relation to the signal light and the local light, and thereby controls the wavelength of the local light generated by the local oscillation light source.

5. The coherent optical receiver according to claim 2, wherein the wavelength detection unit includes:
an optical splitter that causes the second signal light to diverge to first divergence light and second divergence light;
a first opto-electric conversion unit that outputs a first electric signal corresponding to a power of the first divergence light after transmitting through the optical filter;
a second opto-electric conversion unit that outputs a second electric signal corresponding to a power of the second divergence light which does not transmit through the optical filter; and
an operation processing unit that calculates a difference between the first electric signal and the second electric signal, and detects a wavelength of the second signal light on the basis of a correspondence table representing a correspondence between the difference and a wavelength suffering the transmission loss corresponding to the difference is given.

6. The coherent optical receiver according to claim 4, wherein the wavelength detection unit includes:
an optical switch that selects and outputs either the second signal light or the second local light inputted to the optical switch;
an optical splitter that causes the light selected and outputted by the optical switch to diverge to first divergence light and second divergence light;
a first opto-electric conversion unit that outputs a first electric signal corresponding to a power of the first divergence signal after transmitting through the optical filter;
a second opto-electric conversion unit that outputs a second electric signal corresponding to a power of the second divergence signal which does not transmit through the optical filter; and
an operation processing unit that calculates a difference between the first electric signal and the second electric signal, detects a wavelength of the light selected and outputted by the optical switch on the basis of a correspondence table representing a correspondence between the difference and a wavelength suffering the transmission loss corresponding to the difference is given, detects a wavelength of the second signal light and a wavelength of the second local light by switching a selection of the optical switch to respective ones of the second signal light and the second local light, and outputs wavelength misalignment information in relation to the signal light and the local light.

7. The coherent optical receiver according to claim 1, further comprising:
an opto-electric conversion unit that performs an opto-electric conversion of the interference light outputted by the optical phase hybrid unit and outputting an electric signal;
an A/D conversion unit that converts the electric signal into a digital signal and outputs the digital signal; and
a digital signal processing unit that receives the electric signal currently converted into the digital signal, performs signal-waveform equalization processing and demodulation processing on the received electric signal, and thereby outputs a signal currently applied to the signal light.

8. (canceled)

9. (canceled)

10. (canceled)

11. The coherent optical receiver according to claim 2, wherein the wavelength detection unit includes:
an optical splitter that causes inputted light to diverge to first input light and second input light; and
an operation processing unit that detects a wavelength of the inputted light on the basis of information related to a difference between a power of the first input light after transmitting through the optical filter and a power of the second input light which does not transmit through the optical filter.

12. The coherent optical receiver according to claim 2, comprising a local light divergence unit that causes the local light to diverge to first local light inputted to the optical phase hybrid unit and second local light inputted to the wavelength detection unit,
wherein the wavelength detection unit includes an optical switch that selects either the inputted second signal light or second local light and outputs selected light, and an operation processing unit that detects a wavelength of light selected and outputted by the optical switch on the basis of an outputted electric signal corresponding to a power of light after transmitting through the optical filter, detects a wavelength of the second signal light and a wavelength of the second local light by switching a selection of the optical switch to the second signal light or the second local light, and outputs wavelength misalignment information in relation to the signal light and the local light.

13. The coherent optical receiver according to claim 4, wherein the wavelength detection unit outputs maintenance information in relation to wavelength misalignment regarding the signal light and the local light on the basis of the detected wavelength of the signal light and the detected wavelength of the local light.

14. A local light switching method comprising:
causing signal light to diverge to first signal light and second signal light, the first signal light being inputted to an optical phase hybrid unit that causes the first signal light to interfere with local oscillating light (local light) and outputs interference light, the second signal light being inputted to a wavelength detection unit;
in the wavelength detection unit, detecting a wavelength of the signal light on the basis of the second signal light, and performing control of a wavelength of the local light generated by the local oscillation light source.

15. The local light switching method according to claim 14, including:
inputting the light having been inputted to the wavelength detection unit to an optical filter whose transmission loss has a wavelength dependency; and
detecting a wavelength of the light having been inputted to the wavelength detection unit on the basis of a power of the light at a time after transmitting through the optical filter.

16. The coherent optical receiving method according to claim 14, causing the local light to diverge to first local light inputted to the optical phase hybrid unit and second local light inputted to the wavelength detection unit, and detecting an output of the local oscillation light source by detecting a power of the second local light having been inputted to the wavelength detection unit.

17. The coherent optical receiving method according to claim 16, including: detecting a wavelength of the local light on the basis of the second local light having been inputted to the wavelength detection unit; detecting wavelength misalignment information in relation to the signal light and the local light; and controlling the wavelength of the local light generated by the local oscillation light source.

18. The coherent optical receiving method according to claim 15, including: causing to diverge the light having been inputted to the wavelength detection unit to first input light and second input light; and detecting a wavelength of the inputted light on the basis of difference information related to a difference between a power of the first input light at a time after transmitting through the optical filter and a power of the second input light which does not transmit through the optical filter.

19. The local light switching method according to claim 15, including:
causing the light having been inputted to the wavelength detection unit to diverge to first divergence light and second divergence light;
calculating a difference between a first electric signal corresponding to a power of the first divergence light at a time after transmitting through the optical filter and a second electric signal corresponding to a power of the second divergence light which does not transmit though the optical filter; and
detecting a wavelength of the light having been inputted to the wavelength detection unit on the basis of a correspondence table representing a correspondence between the difference and a wavelength from which the transmission loss corresponding to the difference is given.

20. The coherent optical receiving method according to claim 17, including:
outputting selected light resulting from selecting any one of the second signal light and the second local light which have been inputted to the wavelength detection unit;
causing the selected light to diverge to first divergence light and second divergence light;
calculating a difference between a first electric signal corresponding to a power of the first divergence light at a time after transmitting through the optical light and a second electric signal corresponding to a power of the second divergence light which does not transmit through the optical light;
detecting a wavelength of the selected light on the basis of a correspondence table representing a correspondence between the difference and a wavelength from which the transmission loss corresponding to the difference is given;
detecting a wavelength of the second signal light and a wavelength of the second local light by switching a selection of the selected light to respective ones of the second signal light and the second local light; and
outputting wavelength misalignment information in relation to the signal light and the local light.

21. The local light switching method according to claim 15, including:
causing the local light to diverge to first local light inputted to the optical phase hybrid unit and second local light inputted to the wavelength detection unit;
outputting selected light resulting from selecting any one of the second signal light and the second local light which have been inputted to the wavelength detection unit; detecting a wavelength of the selected light on the basis of an outputted electric signal corresponding to a power of light at a time after transmitting through the optical filter;
detecting a wavelength of the second signal light and a wavelength of the second local light by switching the selected light to respective ones of the second signal light and the second local light; and
outputting wavelength misalignment information in relation to the signal light and the local light.

22. The coherent optical receiving method according to claim 17, including outputting maintenance information in relation to wavelength misalignment in relation to the signal light and the local light on the basis of the wavelength of the signal light and the wavelength of the local light, the wavelengths being detected by the wavelength detection unit.

23. A coherent optical receiver comprising:
signal light divergence means for causing signal light to diverge to first signal light and second signal light;
local oscillation light source for generating local oscillating light (local light);
optical phase hybrid means for causing the first signal light to interfere with the local light and outputting an interference light; and
wavelength detection means for receiving the second signal light, detecting a wavelength of the signal light on the basis of the second signal light, and thereby controlling a wavelength of the local light generated by the local oscillation light source.
